(19) United States
(12) Patent Application Publication
(10) Pub. No.: US 2026/0188955 A1
(43) Pub. Date: Jul. 2, 2026

(54) MOUNTING INTERFACE FOR HIGH DENSITY, HIGH SPEED ELECTRICAL CONNECTOR

(71) Applicant: Amphenol Corporation, Wallingford, CT (US)

(72) Inventors: David Levine, Amherst, NH (US); Michael Joseph Snyder, Merrimack, NH (US)

(73) Assignee: Amphenol Corporation, Wallingford, CT (US)

(21) Appl. No.: 19/434,621

(22) Filed: Dec. 29, 2025

Related U.S. Application Data
(60) Provisional application No. 63/740,831, filed on Dec. 31, 2024.
(60) Provisional application No. 63/870,335, filed on Aug. 26, 2025.

(51) Int. Cl. H01R 13/6587; H01R 12/70; H01R 12/71; H01R 13/24; H01R 13/506; H01R 13/518

(52) U.S. Cl. CPC H01R 13/6587; H01R 12/7064; H01R 12/712; H01R 13/245; H01R 13/506; H01R 13/518

(57) ABSTRACT

A high speed, high density electrical connector. The connector includes conductive elements for carrying signals, such as differential signals, with compliant portions for making pressure mount connectors. The distal ends of the signal conductors may have, in one portion a radius of curvature that provides suitable pressure for mounting to a substrate and in other portions, a larger radius of curvature, which results in a desired impedance profile. The compliant portions may be configured to establish desired signal current flow and desired ground current in shields bounding the signal conductors, particularly adjacent to the compliant portions. The compliant portions may have structures that more evenly distribute rotation over the length of the compliant portion. Such techniques facilitate manufacture of closely spaced signal units that each carry a signal with high signal integrity and low crosstalk at 100 GHz or above to support data rates of 224 Gbps and beyond.

### CROSS-REFERENCE TO RELATED APPLICATIONS

This application claims priority to and the benefit under 35 U.S.C. § 119(e) of: U.S. Provisional Patent Application Ser. No. 63/870,335, filed on Aug. 26, 2025, entitled “MOUNTING INTERFACE FOR HIGH DENSITY, HIGH SPEED ELECTRICAL CONNECTOR,” and U.S. Provisional Patent Application Ser. No. 63/740,831, filed on Dec. 31, 2024, entitled “MOUNTING INTERFACE FOR HIGH DENSITY, HIGH SPEED ELECTRICAL CONNECTOR,” the contents of each of which are incorporated herein by reference in their entirety.

### FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, such as printed circuit boards (“PCBs”), which may be joined together with electrical connectors. A known arrangement for joining several printed circuit boards is to have one printed circuit board serve as a backplane. Other printed circuit boards, called “daughterboards” or “daughtercards,” may be connected through the backplane.

A backplane is a structure within an equipment rack with many interconnected connectors. The connections may be formed by conducting traces in a printed circuit board or cables that route signals between the connectors. Daughtercards, also with connectors mounted on them, may be plugged into the connectors of the backplane. In this way, signals may be routed among the daughtercards through the backplane. The daughtercards may plug into the backplane at a right angle to a surface of the backplane to which connectors are mounted. The daughtercard connectors used for these applications may therefore include a right angle bend and are often called “right angle connectors.” The connectors connected to the backplane, sometimes referred to as header connectors, may have signal conductors with intermediate portions that pass through the connector without bends.

In some system configurations, one or more daughtercards may be connected to another circuit board, sometimes called a mother board, with the edges of the daughter cards facing and orthogonal to an edge of the mother board. This configuration is sometimes referred to as an orthogonal configuration. One or both of the mating connectors in an orthogonal configuration may be a right angle connector. In some systems, a right angle connector usable with a backplane may also be used in an orthogonal configuration.

An example of a right angle connector that may mate with a connector usable in a backplane is shown in U.S. Pat. No. 11,742,601. An example of a header connector is shown in U.S. Pat. No. 11,824,311. An example of a right angle connector that has pressure mount contacts is shown in U.S. Pat. No. 11,637,389.

### BRIEF SUMMARY

Aspects of the present application relate to a mounting interface for high density, high speed electrical connectors.

Some embodiments relate to an electrical connector. The electrical connector may comprises a pair of signal conductors having contact tails adapted for connection to a surface of a substrate in an insertion direction, wherein each of the contact tails comprises: a plurality of segments spaced from one another in the insertion direction and comprising a first segment spaced from another of the plurality of segments in the insertion direction and comprising: a rounded tip protruding in the insertion direction and configured to apply pressure to the surface of the substrate; and wings alongside the rounded tip and configured to tune an impedance of the contact tail, wherein the plurality of segments are configured to compress along the insertion direction when the rounded tip is pressed against the surface of the substrate in the insertion direction.

Some embodiments relate to an electrical connector comprising a mounting face. The electrical connector may comprise a housing; and a plurality of conductive elements held within the housing, each of the plurality of conductive elements comprising: a mating contact portion; a contact tail extending from the housing at the mounting face; a compliant portion coupled to the contact tail and movable with respect to the housing in a first direction perpendicular to the mounting face; and an intermediate portion, held within the housing, coupling the mating contact portion to the compliant portion, wherein the contact tail comprises, at the mounting face, an edge comprising a rounded tip having a first radius of curvature and a portion directly adjacent the rounded tip having a second radius of curvature larger than the first radius of curvature.

Some embodiments relate to an electrical connector. The electrical connector may comprise a pair of signal conductors having contact tails adapted for connection to a surface of a substrate in an insertion direction, wherein each of the contact tails comprises: a plurality of segments spaced from one another in the insertion direction and comprising a first segment spaced from another of the plurality of segments in the insertion direction and comprising a rounded tip having a radius between 0.1 mm and 0.2 mm, wherein the plurality of segments are configured to compress along the insertion direction when the rounded tip is pressed against the surface of the substrate in the insertion direction.

Some embodiments relate to an electrical connector comprising a mounting face. The electrical connector may comprise a housing; and a plurality of conductive elements held within the housing, each of the plurality of conductive elements comprising: a mating contact portion; a contact tail extending from the housing at the mounting face; a compliant portion coupled to the contact tail and movable with respect to the housing in a first direction perpendicular to the mounting face; and an intermediate portion, held within the housing, coupling the mating contact portion to the compliant portion, wherein the contact tail comprises, at the mounting face, a rounded tip having a radius between 0.1 mm and 0.2 mm protruding in the first direction.

Some embodiments relate to an electrical connector. The electrical connector may comprise a pair of signal conductors having contact tails adapted for connection to a surface of a substrate in an insertion direction, wherein each of the contact tails comprises: a plurality of segments spaced from one another in the insertion direction, a first segment of the plurality of segments comprising a first tab protruding towards a second segment of the plurality of segments, wherein: the plurality of segments are configured to compress along the insertion direction when the contact tail is pressed against the surface of the substrate in the insertion direction; the plurality of segments are configured to rotate about an axis parallel to the insertion direction when compressed; and the first tab is configured to limit movement of the first segment and the second segment toward one another when the plurality of segments are compressed.

Some embodiments relate to an electrical connector. The electrical connector may comprise a pair of signal conductors having contact tails adapted for connection to a surface of a substrate in an insertion direction, wherein each of the contact tails comprises: a plurality of segments spaced from one another in the insertion direction, wherein: the plurality of segments are configured to compress against one another along the insertion direction when the contact tail is pressed against the surface of the substrate in the insertion direction; the plurality of segments are configured to rotate about an axis parallel to the insertion direction when compressed; and a first segment of the plurality of segments is configured to limit rotation of a second segment of the plurality of segments with respect to the first segment to 4 degrees or less when the first segment and a third segment of the plurality of segments are compressed towards one another along the insertion direction.

Some embodiments relate to an electrical connector comprising a mounting face. The electrical connector may comprise: a housing; and a plurality of conductive elements held within the housing, each of the plurality of conductive elements comprising: a mating contact portion; a contact tail extending from the housing at the mounting face; a compliant portion coupled to the contact tail and movable with respect to the housing in a first direction perpendicular to the mounting face; and an intermediate portion, held within the housing, coupling the mating contact portion to the compliant portion, the intermediate portion comprising a slot, wherein the housing comprises a hub press fit within the slot.

Some embodiments relate to an electrical connector. The electrical connector may comprise a pair of signal conductors having contact tails adapted for connection to a surface of a substrate in an insertion direction, wherein each of the contact tails comprises: a plurality of segments spaced from one another in the insertion direction and comprising a first segment spaced from another of the plurality of segments in the insertion direction and comprising a tip, wherein: the plurality of segments are configured to compress along the insertion direction when the tip is pressed against the surface of the substrate in the insertion direction; the plurality of segments comprise copper titanium (Cu—Ti); and the tip comprises plating that is more conductive than Cu—Ti.

Some embodiments relate to an electrical connector comprising a mounting face. The electrical connector may comprise a housing; and a plurality of conductive elements held within the housing, each of the plurality of conductive elements comprising: a mating contact portion; a contact tail extending from the housing at the mounting face and comprising a tip at the mounting face; a compliant portion coupled to the contact tail and movable with respect to the housing in a first direction perpendicular to the mounting face; and an intermediate portion, held within the housing, coupling the mating contact portion to the compliant portion, wherein the compliant portion comprises copper titanium (Cu—Ti) and the tip comprises plating that is more conductive than Cu—Ti.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electrical connector, according to some embodiments.

FIG. 1B is a partially exploded perspective view of the electrical connector of FIG. 1A.

FIG. 1C is a perspective view of wafers of the electrical connector of FIG. 1A, with housing components hidden and showing wafers therein.

FIG. 1D is a front view of the wafers of the electrical connector of FIG. 1C, showing a mating interface.

FIG. 2A is a perspective view of a wafer of the electrical connector of FIG. 1A, showing a first side (e.g., left side looking from the mating interface).

FIG. 2B is a perspective view of the wafer of FIG. 2A, showing a second side (e.g., right side looking from the mating interface) opposite the first side.

FIG. 2C is a partially exploded left side view of the wafer of FIG. 2A, showing a wafer subassembly and wafer housing.

FIG. 2D is a partially exploded right side view of the wafer of FIG. 2B, showing the wafer subassembly and wafer housing.

FIG. 3A is a perspective view of the wafer subassembly of FIG. 2C, showing the first side.

FIG. 3B is an elevation view of the wafer subassembly of FIG. 3A.

FIG. 3C is a perspective view of the wafer subassembly of FIG. 3A, showing the second side.

FIG. 3D is a perspective view of the wafer subassembly of FIG. 3C, with second side conductive members for the second and fourth pairs of signal conductors and a second side outer insulative member hidden.

FIG. 4A is a perspective view of the wafer subassembly of FIG. 3A, with conductive members hidden.

FIG. 4B is a partially exploded view of the wafer subassembly of FIG. 4A, showing an inner insulative member supporting signal conductors, mating end insulative members, and outer insulative members.

FIG. 5A is a perspective view of conductive elements of the wafer subassembly of FIG. 4A.

FIG. 5B is an elevation view of the conductive elements of FIG. 5A.

FIG. 5C is a front view of the conductive elements of FIG. 5A.

FIG. 5D is a cross-sectional front view of the conductive elements along a line marked “5D-5D” in FIG. 5B.

FIG. 6A is a first side, perspective view of the inner insulative member supporting the signal conductors and mating end insulative members of FIG. 4B.

FIG. 6B is an enlarged view of a portion of the inner insulative member supporting the signal conductors and mating end insulative members within a dashed box marked “6B” in FIG. 6A.

FIG. 6C is an enlarged view of a portion of the inner insulative member supporting the signal conductors and mating end insulative members within a dashed box marked “6C” in FIG. 5A.

FIG. 6D is a second side, perspective view of the inner insulative member supporting signal conductors and mating end insulative members of FIG. 6A.

FIG. 7A is a first side, perspective view of the inner insulative member and mating end insulative members of FIG. 6A, with one of the mating end insulative members disconnected from the inner insulative member.

FIG. 7B is a second side, perspective view of the inner insulative member and mating end insulative members of FIG. 7A.

FIG. 8A is a first side, perspective view of the inner insulative member of FIG. 7A.

FIG. 8B is a second side, perspective view of the inner insulative member of FIG. 8A.

FIG. 8C is a front view of the inner insulative member of FIG. 8A.

FIG. 9A is a perspective view of the mating end insulative member of FIG. 7A.

FIG. 9B is an elevation view of the mating end insulative member of FIG. 9A, looking from a direction marked “9B” in FIG. 9A.

FIG. 9C is another elevation view of the mating end insulative member of FIG. 9A, looking from a direction marked “9C” in FIG. 9A.

FIG. 9D is a plan view of the mating end insulative member of FIG. 9A, looking from a direction marked “9D” in FIG. 9A.

FIG. 10 is a perspective, first side view of the outer insulative members of FIG. 4B.

FIG. 11A is an upper, first side perspective view of the conductive members of the wafer

FIG. 11B is a lower, first side perspective view of the conductive members of FIG. 11A.

FIG. 12A is a perspective view of a contact tail of the conductive elements of FIG. 5A.

FIG. 12B is a perspective view of a first contact tail disclosed in U.S. Pat. No. 11,637,389.

FIG. 12C is a perspective view of a second contact tail disclosed in U.S. Pat. No. 11,637,389.

FIG. 13A is a side perspective view of an end of the wafer subassembly of FIG. 3A with force applied to the contact tails and with the conductive members made transparent, according to some embodiments.

FIG. 13B is a bottom view of the end of the wafer subassembly shown in FIG. 13A.

FIG. 14A is a perspective view of an alternative embodiment of the contact tail of FIG. 12A having a tab between the last segment and the next to last segment of the compliant portion, according to some embodiments.

FIG. 14B is a perspective view of a further alternative embodiment of the contact tail of FIG. 12A having tabs between each pair of segments of the compliant portion, according to some embodiments.

FIG. 15A is an enlarged view of a portion of the inner insulative member and signal conductor shown in FIG. 6C.

FIG. 15B is an enlarged view of the portion of the inner insulative member shown in FIG. 6C with the signal conductor removed.

FIG. 16 is a perspective view of an alternative embodiment of the contact tail of FIG. 14B having tabs with rounded edges between each pair of segments of the compliant portion, according to some embodiments.

FIG. 17A is a perspective view of an alternative embodiment of the contact tail of FIG. 16 having fingers along an edge of the contact tail angled in different respective directions with respect to the insertion direction, according to some embodiments.

FIG. 17B is an enlarged view of a tab recessed into the contact tail of FIG. 17A.

FIG. 18 is a perspective view of an alternative embodiment of the contact tail of FIG. 17A having fewer rungs and longer tabs in the compliant portion, according to some embodiments.

FIG. 19 is a perspective view of a further alternative embodiment of the contact tail of FIG. 17A having fewer rungs and longer fingers in the compliant portion, according to some embodiments.

FIG. 20A is a graph of spring force vs. spring compression for the contact tail of FIG. 16.

FIG. 20B is a graph of spring force vs. spring compression for the contact tail of FIG. 17A.

FIG. 20C is a graph of spring force vs. spring compression for the contact tail of FIG. 18.

FIG. 20D is a graph of spring force vs. spring compression for the contact tail of FIG. 19.

FIG. 21A is a graph of rung force vs. spring compression for the contact tail of FIG. 16.

FIG. 21B is a graph of rung force vs. spring compression for the contact tail of FIG. 17A.

FIG. 21C is a graph of rung force vs. spring compression for the contact tail of FIG. 18.

FIG. 21D is a graph of rung force vs. spring compression for the contact tail of FIG. 19.

### DETAILED DESCRIPTION

The inventors have recognized and appreciated connector design techniques for high density connectors that can support greater bandwidth through high frequency operation and be economically mass produced. These techniques include designs for a mounting interface of the connector that enable operation at high frequency without resonances or other degradation of signal integrity while balancing the need for a reliable mechanical connection to a printed circuit board or other substrate. The mounting interface may be used in a high density connector, such as having a pair-to-pair pitch of less than or equal to 2.8 mm in both a row and column direction, such as 2.4 mm in both a row and column direction, and can operate at 100 GHz or above and transmit data at 224 Gbps and beyond.

In some embodiments, a contact tail may have a compliant portion configured to be compressed in an insertion direction, a rounded tip protruding in the insertion direction and configured to apply pressure to a surface of a substrate, and wings alongside the rounded tip and configured to tune an impedance of the contact tail.

The inventors have recognized and appreciated designs for compliant conductive elements that simultaneously meet multiple requirements for a high speed, high density connector, including generating sufficient pressure without applying pressure that is so large as to damage contact pads on a substrate while maintaining a desirable impedance through the conductive elements. A contact tail with a distal edge including a rounded portion over a fraction of the length of the edge may apply sufficient, but not excessive, pressure. The contact tail may include wings on either or both sides of the rounded portion. The wings may tune the impedance of the contact tail. With such a contact tail, sufficient pressure may be obtained when the contact tail is compressed to form a reliable connection with a desirably low impedance at the interface.

For example, a rounded tip having a radius between 0.1 mm and 0.2 mm may be used. In contrast, pointier tips with smaller radii may produce sufficient pressure to promote cracking in contact pads on the substrate. More rounded tips, which may have larger radii, may produce insufficient pressure to form a reliable connection in some cases.

In some embodiments, segments of a contact tail may comprise copper titanium (Cu-Ti), which may produce a large spring force in the contact tail to obtain a suitable amount of pressure on a contact pad. In some embodiments, the tip of the contact tail may comprise plating that is more conductive than Cu-Ti, which may provide a desirable low impedance through the conductive element, including adjacent the interface with the contact pad.

Conductive elements as described herein may alternatively or additionally include structures that facilitate an interface between an electrical connector and a substrate with desirable properties. In some examples, an intermediate portion of a signal conductor, coupling a mating contact portion to a compliant portion of the contact tail, may include a slot. A housing of the connector may include a hub press fit within the slot to hold the contact tail in place while compressed, thereby obtaining a suitable amount of pressure from the contact tail on a contact pad on a substrate.

Alternatively or additionally, a contact tail may include one or more features that distributes the rotation of the contact tail over a desired length. Limiting rotation of segments of the contact tail with respect to other segments during compression, may result in gradual transitions in the contact tail which in turn may provide enhanced signal integrity. Without being bound by any particular theory, the inventors theorize that a more gradual transition reduces the maximum separation between the signal conductors and an adjacent ground structure, which results in a return current in the ground structure being closer to the signal conductors, thereby improving signal integrity. In some examples the compliant conductive element may have a compliant portion with a first segment configured to limit rotation of a second segment with respect to the first segment (e.g., to 4 degrees or less) when the first segment and a third segment are compressed towards one another along the insertion direction. For example, the first segment may have a tab configured to limit rotation of the third segment with respect to the first segment, which in turn may limit rotation of the second segment with respect to the first segment.

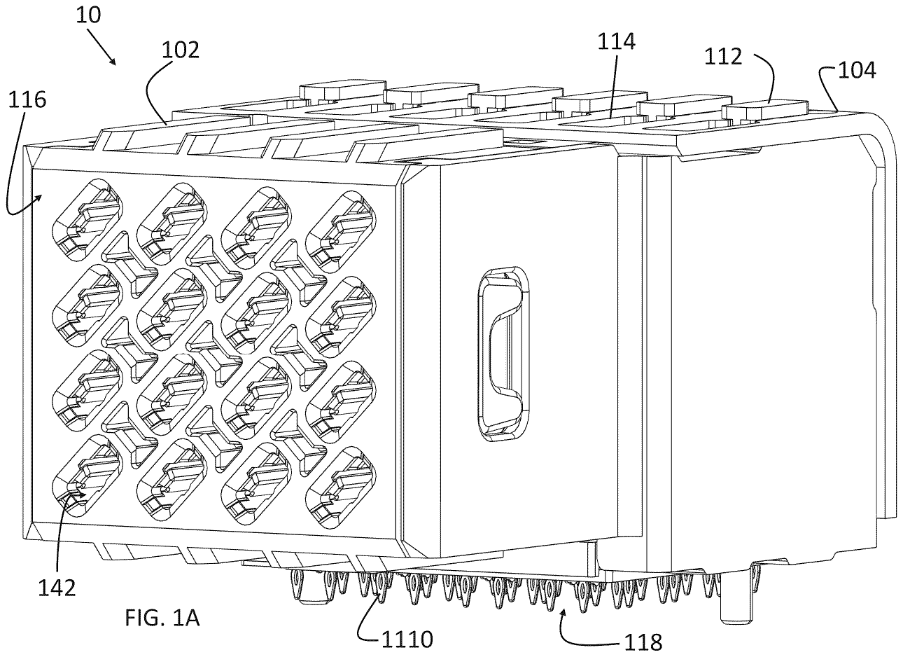

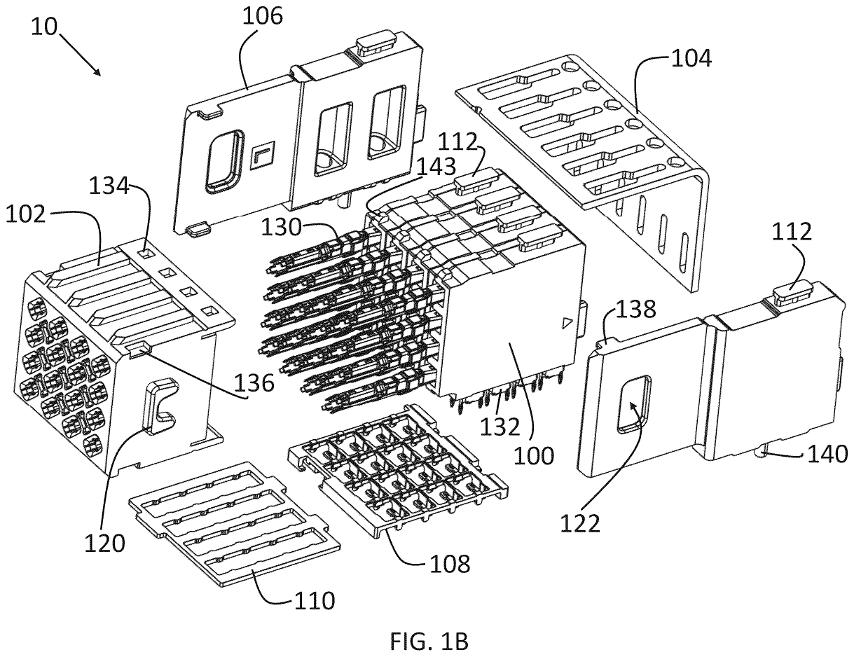

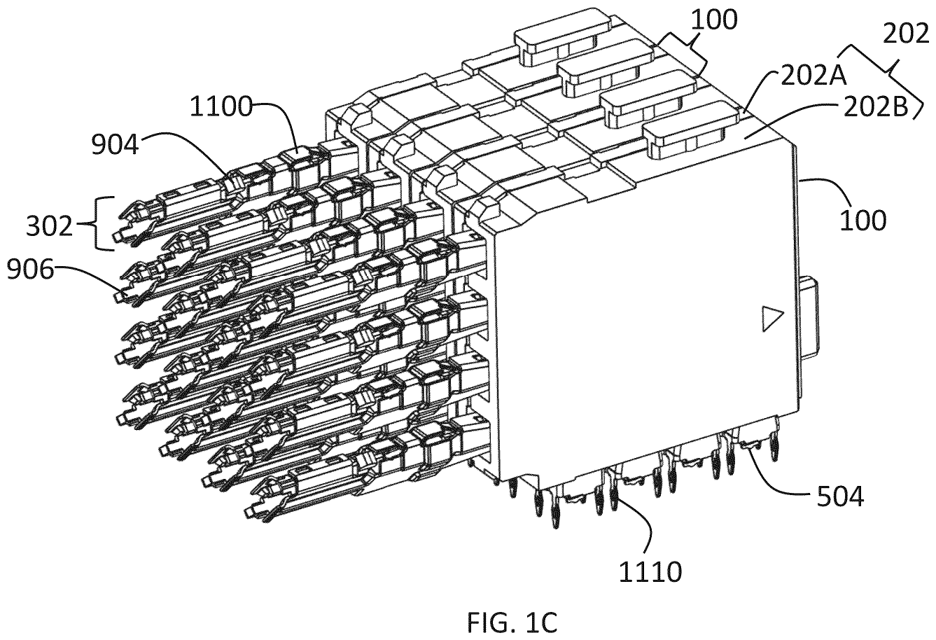

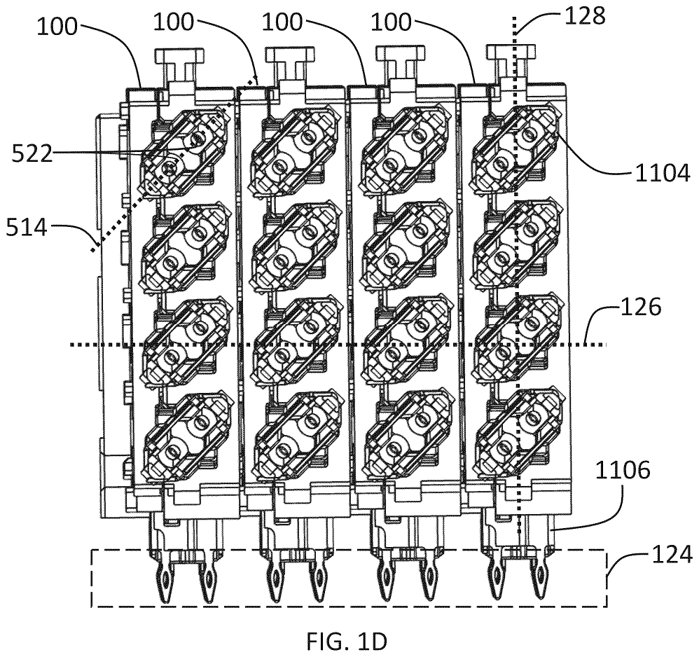

Turning to the figures, FIGS. 1A-1D illustrate an electrical connector 10 that may be implemented in an electrical interconnect system in accordance with some embodiments. In the illustrated example, connector 10 is configured as a right angle connector. Connector 10 may include multiple wafers 100 disposed side by side in a row direction 126, with mating end portions 130 disposed in a front housing 102, forming a mating interface 116, and mounting end portions 132 extend through organizer 108 and compliant shield 110, forming a mounting interface 118. The wafers may be held by a retaining member, an example of which is here shown as stiffener 104. The front housing 102 and the multiple wafers 100 may have complementary features at the top and/or bottom such as openings 134 and protrusions 143 configured to make a secure connection between the front housing 102 and the multiple wafers 100. In the illustrated example, four wafers connected to a front housing are shown, but connector modules may be constructed with more or fewer wafers in a module. Moreover, stiffener 104, though shown with a length conforming to the dimensions of a single connector module, may be made longer to support multiple connector modules as pictured to form a longer connector.

Connector 10 may include side housing members disposed on opposite sides of multiple wafers 100. An example of side housing members is here shown as end caps 106. The side housing members may extend to the sides of the front housing 102. As illustrated, one or both sides of the front housing 102 may have a lug 120 protruding toward opening 122 of a respective end cap 106. Alternatively or additionally, one or both sides of the front housing 102 may also have a groove 136 for receiving a projection 138 extending from a respective end cap 106.

One or both of the end caps 106 may have features for mounting a connector to a substrate. In this example, each end cap 106 has a post 140 configured to be inserted into a hole of a substrate 124. Examples of other features include openings to receive screws passing through the substrate or hold downs soldered to the substrate.

Connector 10 may include stiffener 104 holding the multiple wafers 100 and the end caps 106 at the rear. As illustrated, stiffener 104 may includes slots 114 for receiving retaining tabs 112 of multiple wafers 100 and end caps 106. Interconnecting the housing members (e.g., front housing 102, end caps 106, wafer housing 202 such as including left side member 202A and right side member 202B) as described herein can reduce the risk of relative movements between the housing members, for example, during mating/unmating.

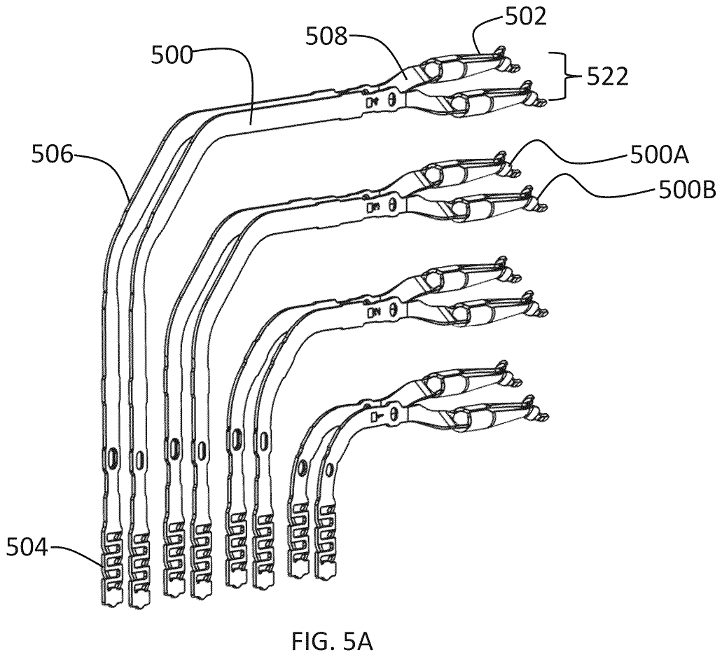

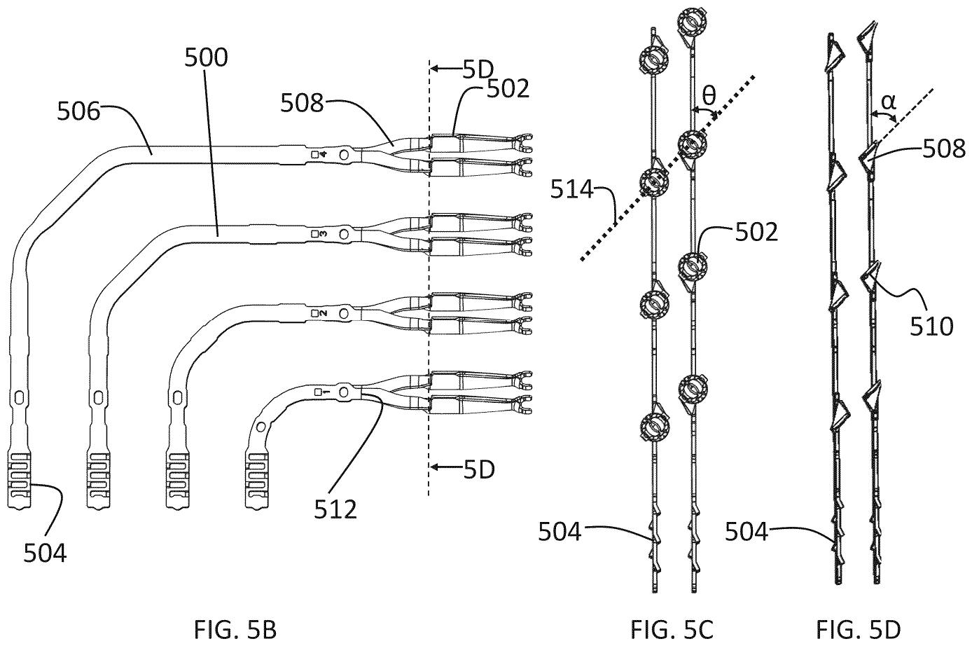

Each wafer 100 may include multiple units 302 held in a column direction 128. In the illustrated example, each unit 302 may include a pair of signal conductors 522 (FIG. 5A), substantially surrounded by conductive structures 1100 over a substantial portion of the length of the pair of signal conductors 522. The conductive structures 1100, which may include one or more pieces, may provide isolation and ground return paths for electrical signals carried by signal pairs of adjacent connector units. In the illustrated example, that conductive structures 1100 may have mating end portions 1104 configured for making contact with ground conductors of a mating component at the mating interface 116 and mounting end portions 1106 configured for making contact with ground conductors of a mating component at the mounting interface 118. The conductive structures 1100 may be formed from electrically conductive material, such as a sheet of metal bent and formed into the illustrated shape so as to form electromagnetic shielding. It should be appreciated that ground conductors need not be connected to earth ground, but are shaped to carry reference potentials, which may include earth ground, DC voltages or other suitable reference potentials.

The mating interface 116 may include apertures 142 through which the mating end portions 130 of the multiple wafers 100 are accessible. As illustrated in FIG. 1C, the mating end portions 130 of the multiple wafers 100 may include arms 906, which may be received in grooves of a mating connector so as to guide mating ends of the mating connector to make contact with the mating ends 502 of the signal conductors 500. As illustrated in FIG. 1D, the mating end portions 130 of the multiple wafers 100 may include mating end portions 1104 of the conductive structures 1100, which may be coupled to ground conductors of a mating connector. A mating connector may include, but is not limited to, an orthogonal board-mounted connector, a (vertical) backplane board-mounted connector, a cable connector terminating a plurality of electrical cables, and/or a hybrid connector having a board-mounted portion and a cable-terminating portion.

The signal conductors 500 may be arranged to provide an angled mating interface. Referring to FIGS. 5A-5D, each signal conductor 500 may include a mating end 502, a mounting end 504, and an intermediate portion 506 between the mating end 502 and mounting end 504. As shown, the pairs of mating ends within a wafer are aligned in a column. The mating ends of each pair are aligned along a line that is transverse to the column. That line in this example is angled with respect to the column at an angle between 30 and 65 degrees, such as 45 degrees, for example.

In the example of a right angle connector illustrated, that position and orientation of pairs of mating ends may be achieved with a transition region 508 in the signal conductors 500, which may twist between the mating end 502 and the intermediate portion 506, such that an end 510 of the transition region 508 connected to the mating end 502 extends in an acute angle (e.g., a in FIG. 5D) to the other end 512 of the transition region 508 that is connected to the intermediate portion 506. As illustrated, the transition region 508 of a signal conductor 500A in a pair may jog upwards while the transition region 508 of the other signal conductor 500B in the pair may jog downwards such that the mating ends 502 of the pair align in a pair direction 514 extending in an acute angle (e.g., 0 in FIG. 5D) to the column direction 128. Referring back to FIG. 1D, in the illustrated example, pairs of mating ends 504 may be connected along lines disposed at a 45 degree angle relative to both the row direction 126 and column direction 128.

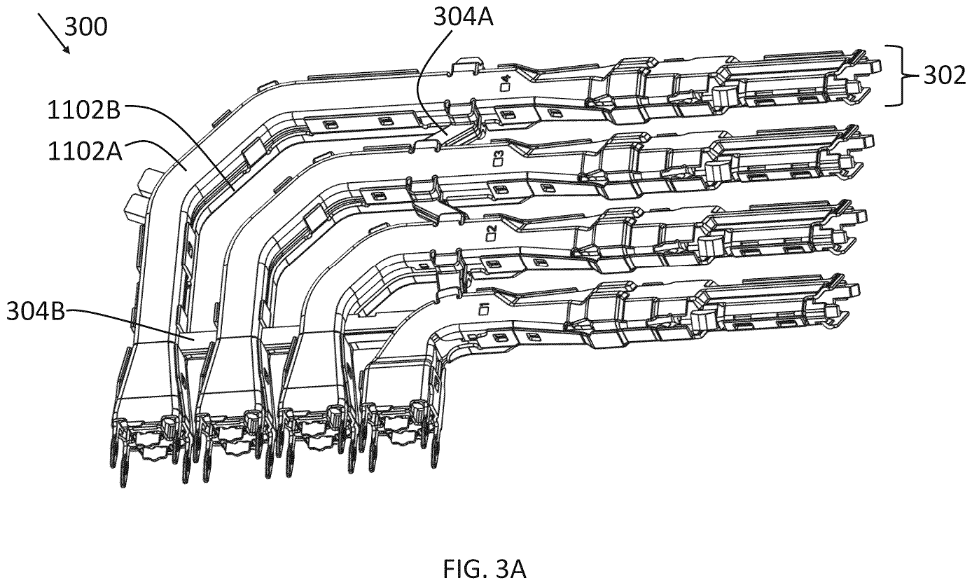

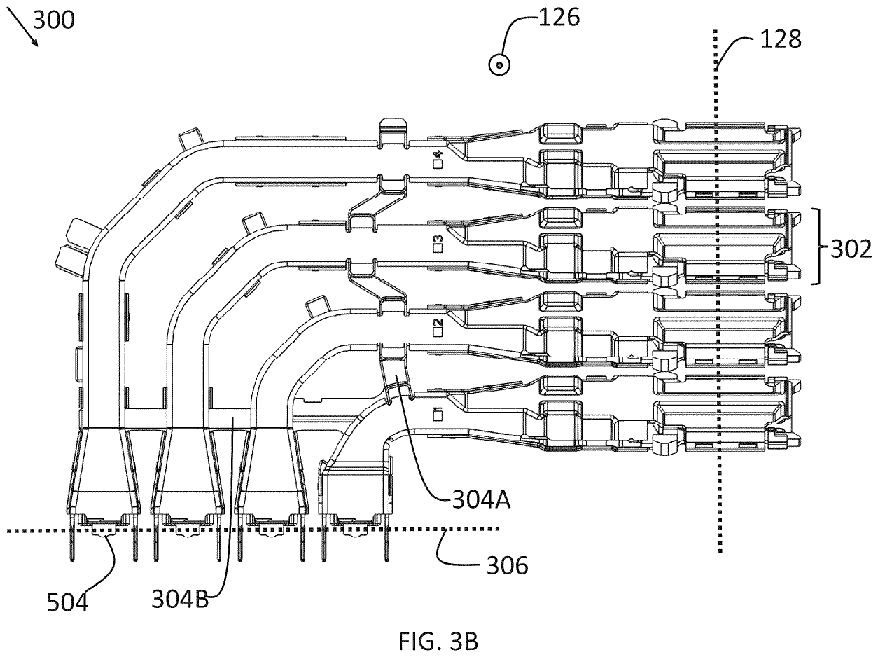

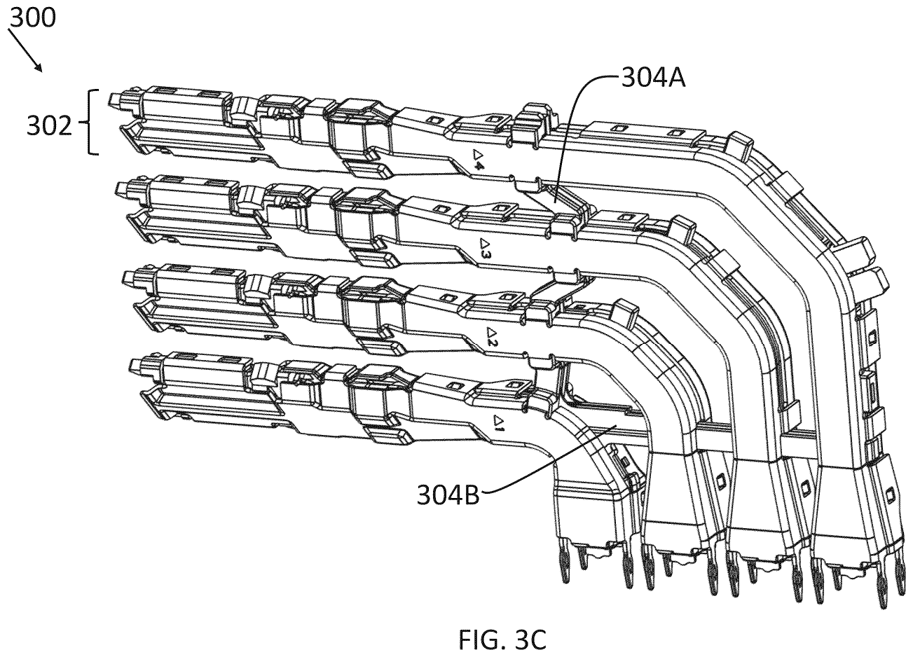

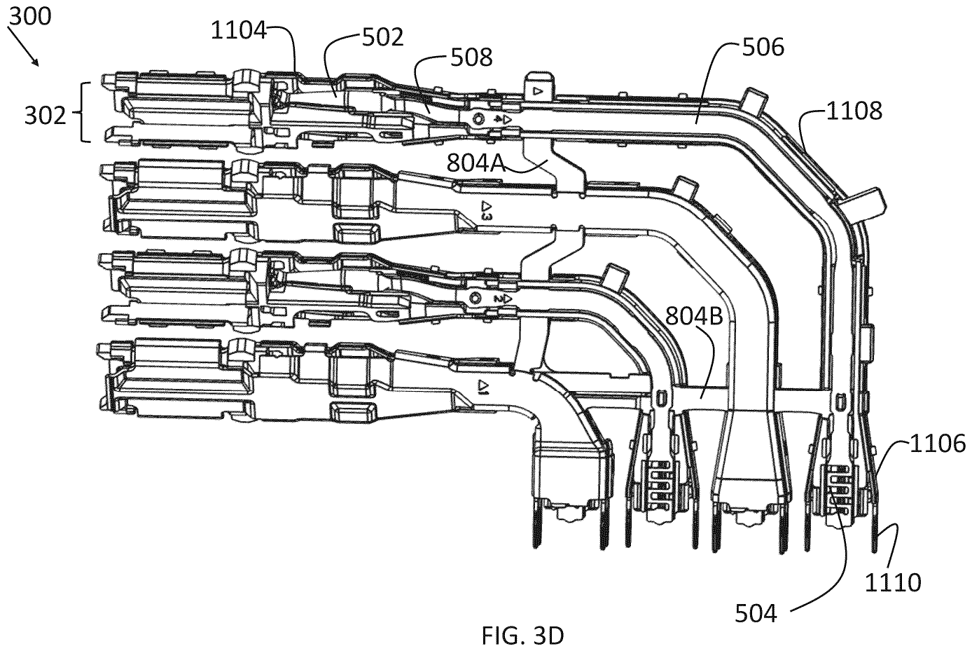

As illustrated in FIG. 1C, the mounting interface 118 may include mounting ends 504 of the signal conductors 500 and mounting ends 1110 of the conductive structures 1100. The mounting ends may be configured for pressure mount, press-fit insertion, solder mount, and/or any other mounting configuration, either for mounting to a printed circuit board or to conductors within an electrical cable. In the illustrated example, the signal conductors 500 may have mounting ends 504 configured for pressure mount; and the conductive structures 1100 may have mounting ends 1110 configured for press-fit insertion. In some embodiments, the mounting ends 504 may be aligned along a mounting column direction (306, FIG. 3B).

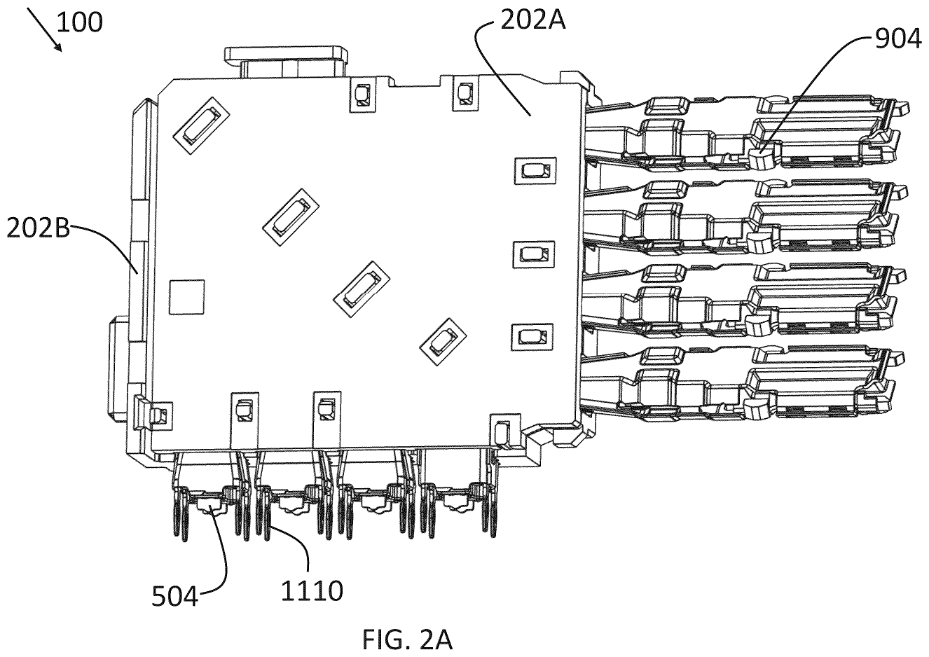

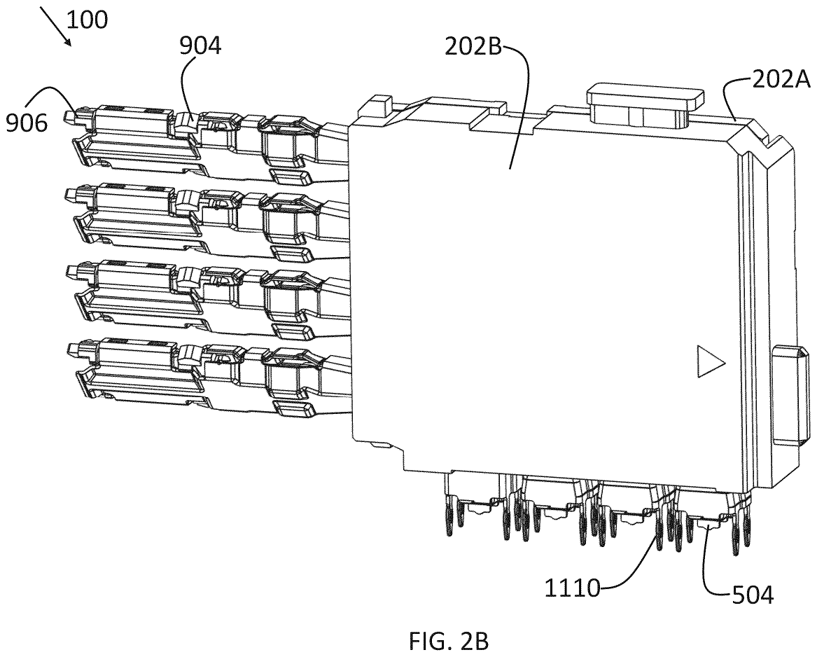

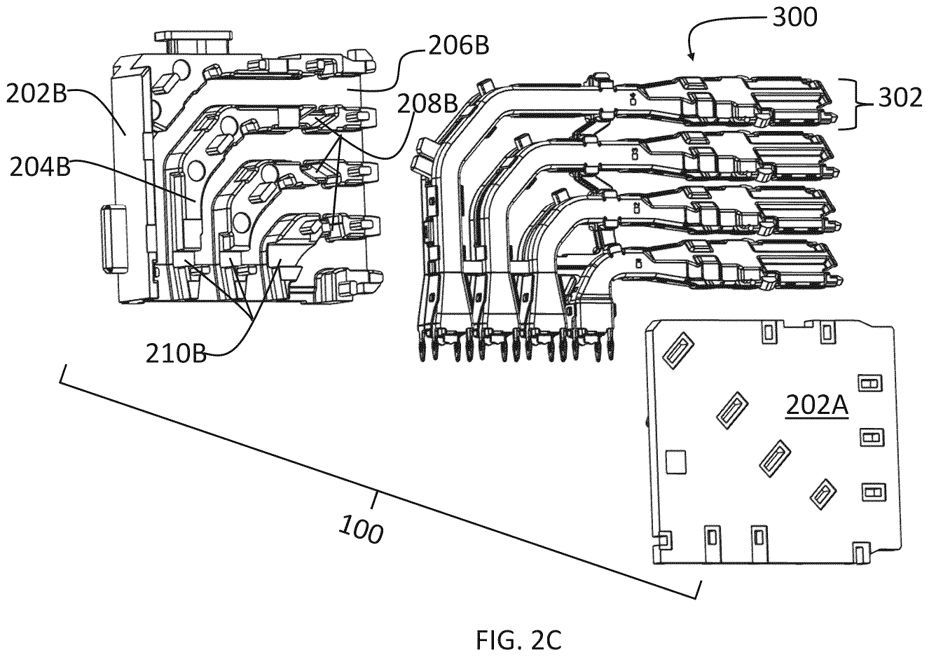

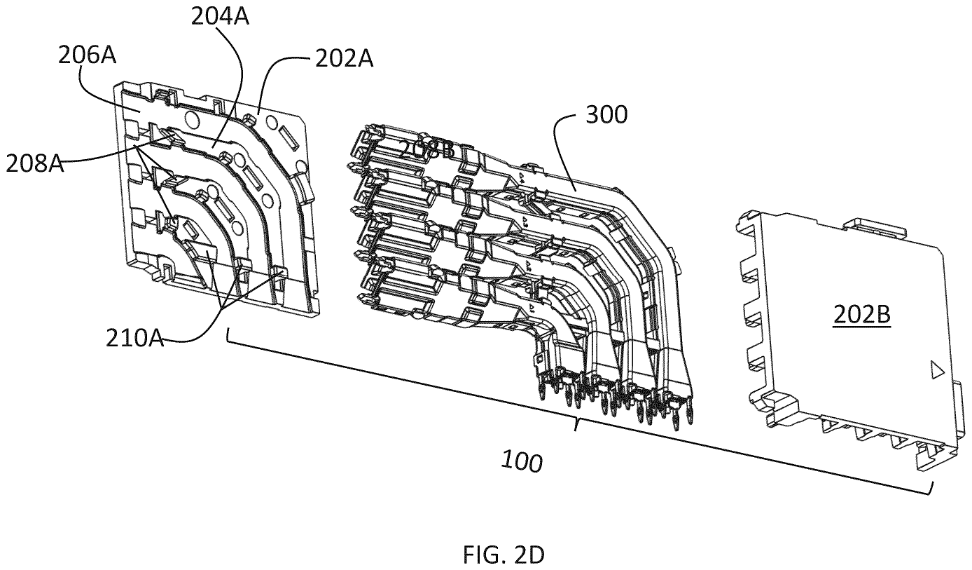

FIGS. 2A-2D illustrate a wafer 100, which may include a subassembly 300 and wafer housing substantially enclosing intermediate portions of the subassembly 300. The subassembly 300 may include multiple units 302 interconnected by elongated members, such as bars 304A and 304B (FIG. 3A).

As illustrated, the wafer housing may include left side member 202A and right side member 202B configured to interlock with each other with the subassembly 300 in between. The side members 202A and 202B may include respective ribs 204A and 204B, defining respective grooves 206A and 206B therebetween. The units 302 may be disposed in respective grooves 206A and 206B. In the illustrated example, the ribs 204B of the right side member 202B may include recesses 208B and 210B where the elongated members can be disposed; and the ribs 204A of the left side member 202A may include protrusions 208A and 210A protruding toward respective recesses 208B and 210B so as to securely hold the elongated members in between.

The wafer housing may be lossy and therefore couple the conductive material of the units and provide damping for undesired resonant modes within and between units 302 without supporting resonances within the operating frequency range of the connector, thereby improving signal integrity of signals carried by electrical connector 10. The wafer housing may be made of lossy material. In examples in which the units of a wafer are interconnected through elongated insulative members, the conductive members encircling each of the units may be separated within the wafer, such that the only connection within the connector among the conductive members is established by the elongated insulative members. Such a configuration may provide desirable signal integrity properties despite closer spacing between the units.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHZ.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Although each wafer 100 includes a wafer subassembly 300 having four units 302, it should be appreciated that the present disclosure is not intended to be limited in these aspects. Each wafer 100 may include any suitable number of wafer subassemblies 300 (e.g., two, three, four, etc.) disposed between the wafer housing members 202A and 202B. Each wafer subassembly 300 may include any suitable numbers of units (e.g., eight, twelve, sixteen, etc.).

FIGS. 3A-3D further illustrate the subassembly 300. Subassembly 300 may include multiple interconnected units 302. Adjacent units 302 may be mechanically connected with elongated members such as bars 304A and 304B. Each unit 302 may include one or more signal conductors 500 and, optionally, conductive structure (e.g., conductive members 1102A and 1102B) providing shielding and/or ground conducting paths associated with the signal conductors of the unit 302. The connections between units 302 may be insulative, such as insulative bars.

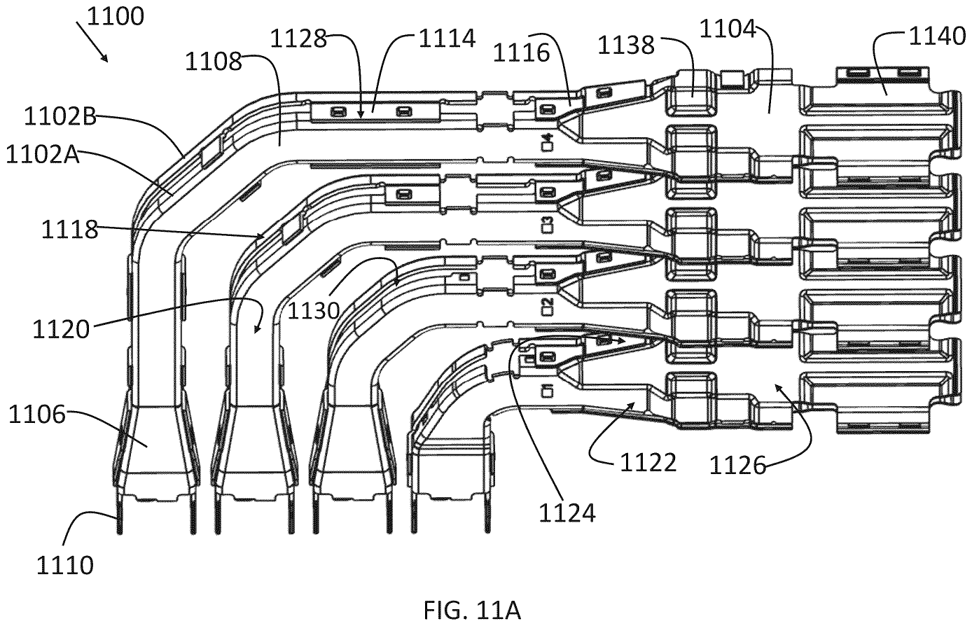

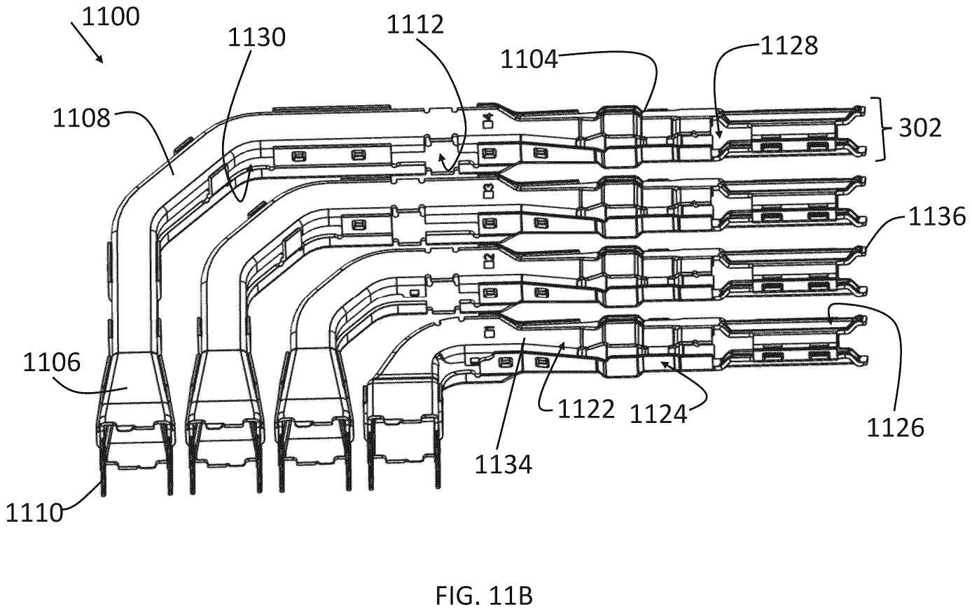

Referring also to FIGS. 11A-11B, the conductive structures 1100 for the units 302 may have apertures 1112 through which the bars extend. The conductive structures 1100 may include a left side member 1102A and a right side member 1102B. The left and right side members 1102A and 1102B may have complementary retaining members, such as buckles 1114 and 1116. Optionally, once buckles are fastened, elongated plate regions of conductive members around the buckles may be spot welded for further mechanical retention.

In the illustrated example, the left and right side members 1102A and 1102B may fully cover the units 302 on sides (which may correspond to broadside of the signal conductors 500), leaving a gap 1130 on the remaining two sides (which may correspond to edges of the signal conductors 500) such that only partial covering is provided on those sides. Gaps 1130 may be relatively narrow, so as not to allow any significant amount of electromagnetic energy to pass through the gaps 1130. The gaps 1130, for example, may be less than one half or, in some embodiments, less than one quarter of a wavelength of the highest frequency in the intended operating range of the connector 10. It should be appreciated that, in some embodiments, the left and right side members 1102A and 1102B may fully cover the units on four sides.

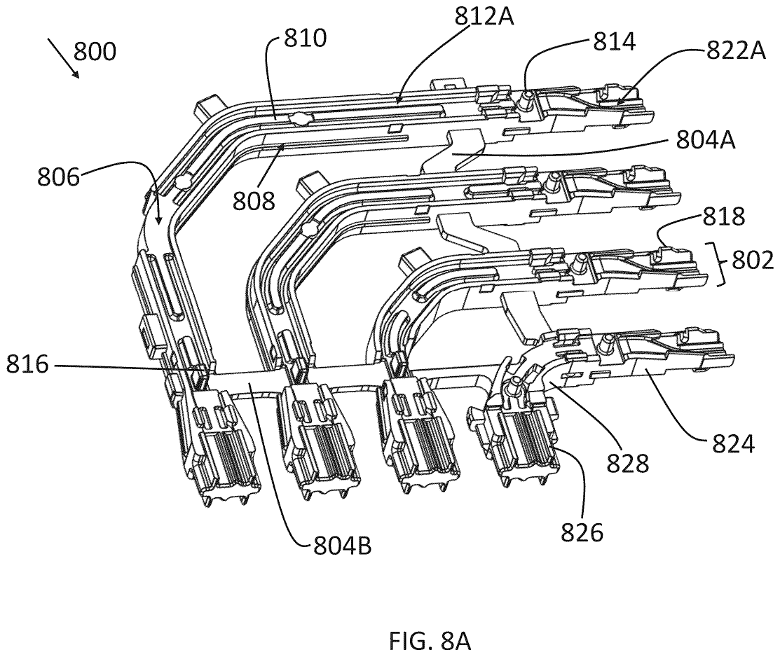

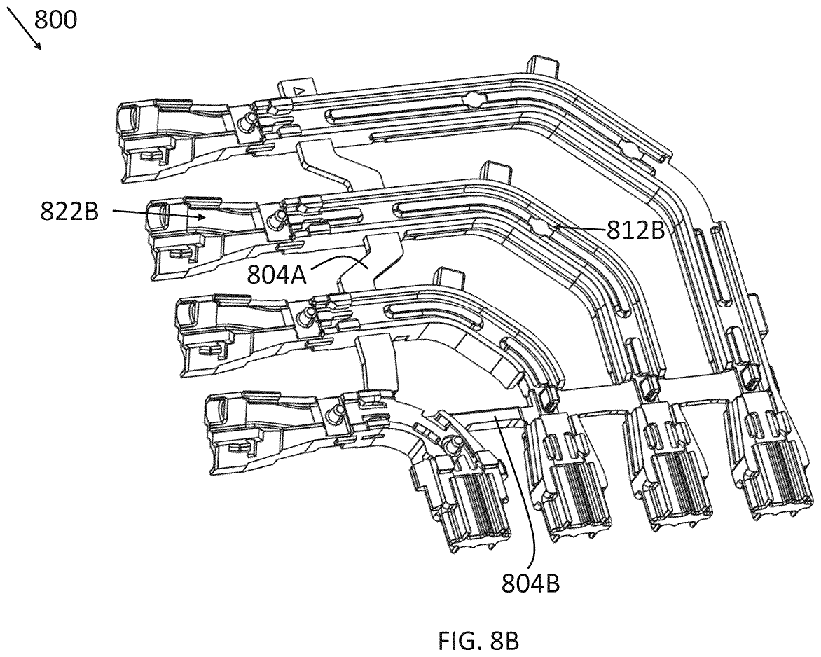

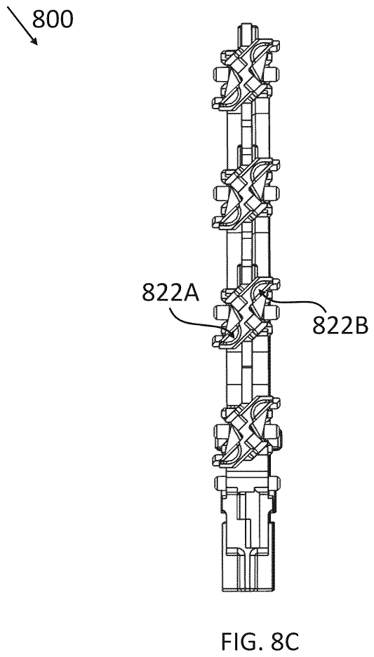

The conductive structures 1100 for each unit 302 may include a mating end portion 1104, a mounting end portion 1106, and an intermediate portion 1108 between the mating end portion 1104 and the mounting end portion 1106. As illustrated, the intermediate portion 1108 may enclose a smaller space than the mating and/or mounting end portions 1104 and 1106. As shown in FIG. 3D, the mating end portion 1104 may substantially surround the mating ends 502 and/or transition regions 508 of the signal conductors 500 in the unit 302 and/or the mating end portion 824 of the inner insulative portions 802 in the unit 302 (see also FIG. 8A). The mating end portion 1104 may twist and/or expand from the intermediate portion 1108 such that the distal end 1136 of the mating end portion 1104 may have more sides than its proximal end 1134 connected to the intermediate portion 1108. In the example illustrated in FIGS. 11A-11B, the proximal end 1134 of each of the conductive members 1102A and 1102B may have two sides (first side 1122, which may extend from the sides 1120 of the intermediate portion 1108, and second side 1124, which may extend from the edges 1118 of the intermediate portion 1108) while the distal end 1136 may have three sides (first side 1122, second side 1124, and third side 1126). The third sides 1126 may extend between respective first side 1122 and second side 1124 and in an acute angle to a plane that the sides 1120 of the intermediate portion 1108 extend.

The mating end portions 1104 of the conductive structures 1100 may be embossed with outwardly projecting (e.g., embossed) portions 1138, which may substantially correspond to the transition region 508 of the signal conductors 500 disposed therein, and inwardly projecting (e.g., embossed) portions 1140, which may substantially correspond to arms 906 of mating end insulative member 900 disposed therein. The outwardly projecting portions 1138 may be disposed between intermediate portions 1108 and inwardly projecting portions 1140.

Embossing electromagnetic shielding mating ends with outwardly projecting portions 1138 may offset changes in impedance along a length of the units 302 associated with changes in shape of the units 302 (e.g., in the transition regions 508 of the signal conductors). An impedance along signal paths through each unit 302 may be between 90 and 100 ohms at frequencies at 100 GHz, for example.

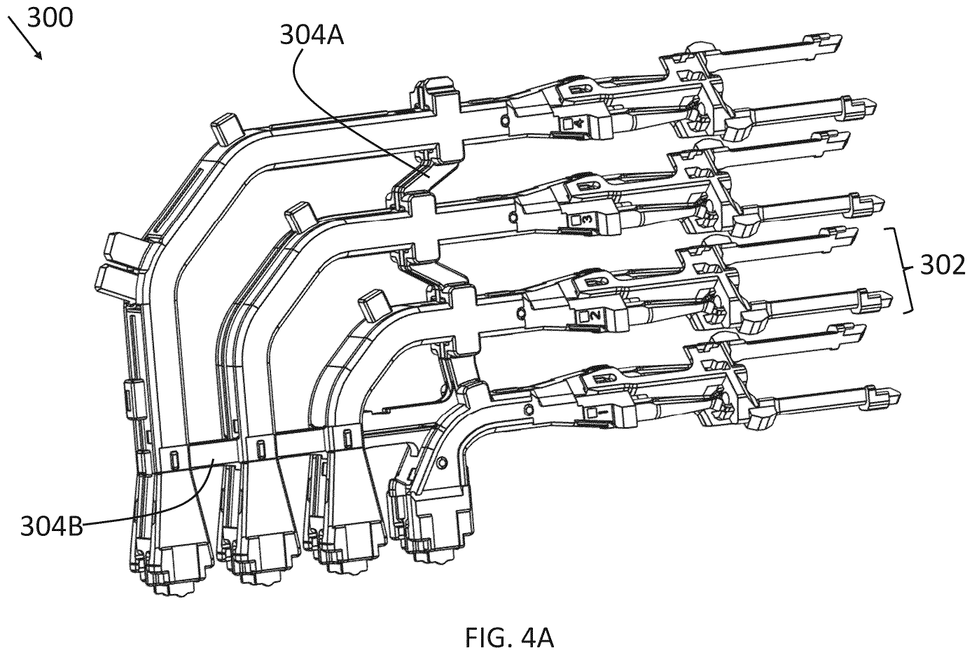

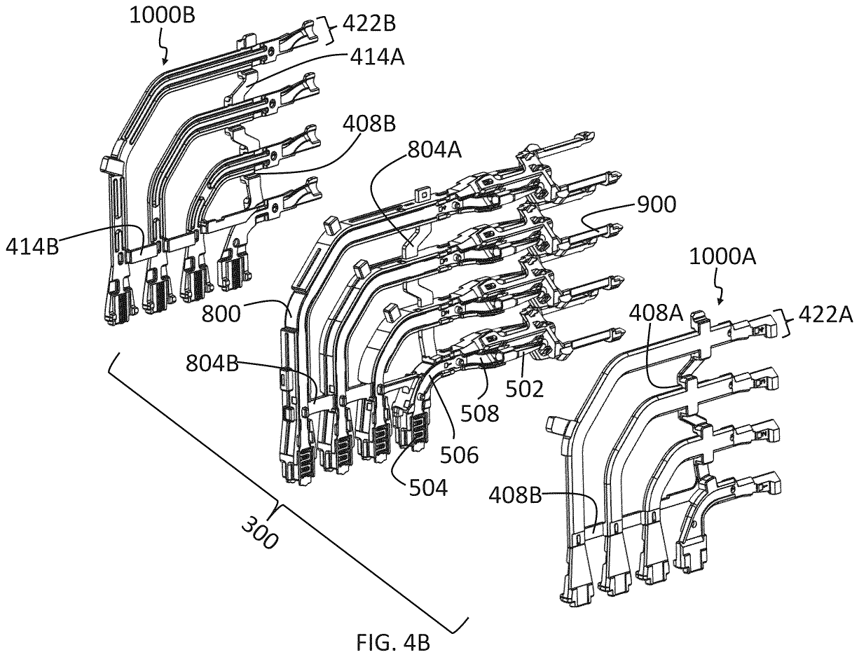

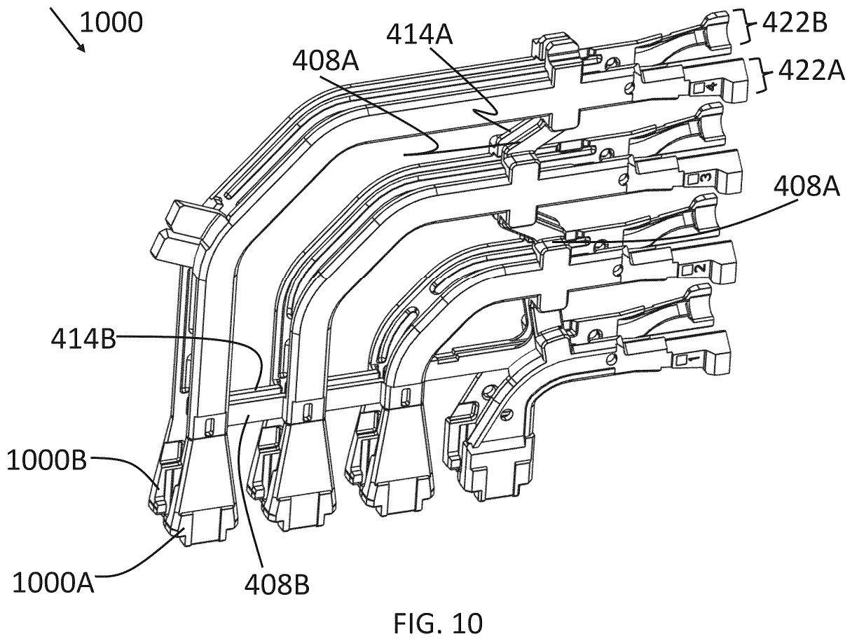

FIGS. 4A-4B show the subassembly 300 with shielding members 1102A and 1102B hidden. As illustrated, each unit 302 may include an insulative portion, which may be assembled from one or more components, such as an inner portion (e.g., inner insulative portion 802 of inner insulative member 800 in FIG. 8A) and one or more outer portions (e.g., outer insulative portion 422A of outer insulative member 1000A and outer insulative portion 422B of outer insulative member 1000B in FIG. 10). One or more signal conductors may be supported by the insulative portion. In some examples, the signal conductors may be inserted into channels (812A, 812B) of the insulative portion. In the example illustrated, intermediate portions of a pair of signal conductors of one unit are broadside coupled and are held on opposite sides of a respective inner insulative portion 802 of the inner insulative member 800. As a specific example, a signal conductor may be disposed between the inner portion and a respective outer portion.

As shown in FIG. 4B, the inner insulative portions 802 of the units 302 in the subassembly 300 may be connected by bars 804A and 804B, enabling the inner portions for all of the interconnected units to be molded in one piece. Alternatively or additionally, the outer insulative portions 422A may be connected by bars 408A and 408B such that the outer insulative member 1000A may be molded in one piece. Similarly, the outer insulative portions 422B may be connected by bars 414A and 414B such that the outer insulative member 1000B may be molded in one piece. The bars 804A, 804B of the inner insulative portions 802 of the inner insulative member 800 may be sandwiched between respective bars 408A, 408B of the units 302 of the outer insulative member 1000A and bars 414A, 414B of the outer insulative portions 422B of the outer insulative member 1000B.

Referring also to FIGS. 8A-8C and 10, the inner insulative portion 802 of each unit 302 may include sides 806 supporting respective signal conductors 500 and edges 808 joining sides. Each of the bars 804A and 804B may extend from a respective edge 808 and may be thinner than the edge. Each bar 804A and 804B may be thinner than the edge and substantially equally spaced from the sides 806 of the inner insulative portion 802.

In examples in which the insulator of the wafer subassembly is formed from multiple components, any number of those components may be connected through insulative bars. In the example illustrated, the insulator has an inner portion and two outer portions, each of which includes multiple portions forming signal units of the wafer subassembly. These portions of the units for each component may be connected by insulative bars that are part of the respective component. In the example illustrated the insulative bars for each component are aligned such that the insulative bar for multiple such components may collectively provide bars joining adjacent units of the wafer subassembly.

For example, each outer insulative portion 422A or 422B of the outer insulative member 1000A or 1000B may include sides supporting respective signal conductors 500 and edges joining sides. Each of the bars 408A, 408B of the outer insulative portions 422A of the outer insulative member 1000A and bars 414A, 414B of the outer insulative portions 422B of the outer insulative member 1000B may extend from a respective edge and may be thinner than the edge. Each of the bars 408A, 408B of the outer insulative portions 422A of the outer insulative member 1000A and bars 414A, 414B of the outer insulative portions 422B of the outer insulative member 1000B may be thinner than the edge and disposed closer to the side that faces the inner insulative member 800. Each bar may be connected to the respective edge by a distance in a range of 1% to 20% of a length of the edge.

The bars may be disposed at selected locations. In the illustrated example, the bars 804A, 408A, 414A are disposed substantially at an end of the intermediate portion 828 that is closer to the mating end portion 824 than the mounting end portion 826. The bars 804B, 408B, 414B are disposed substantially at an end of the intermediate portion 828 that is closer to the mounting end portion 826 than the mating end portion 824. At least the bars adjacent the mating end portion 824 are staggered, which may reduce cross talk.

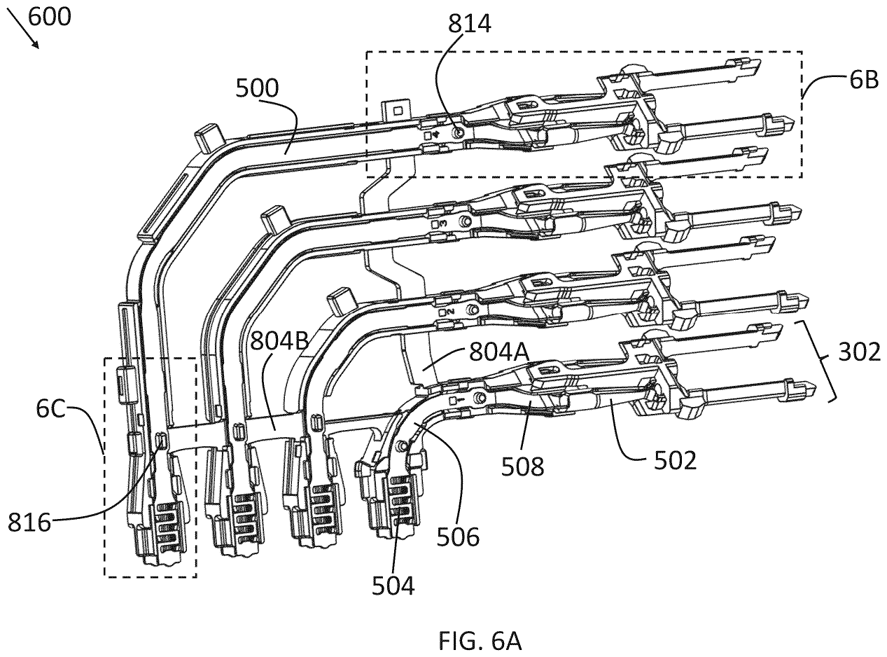

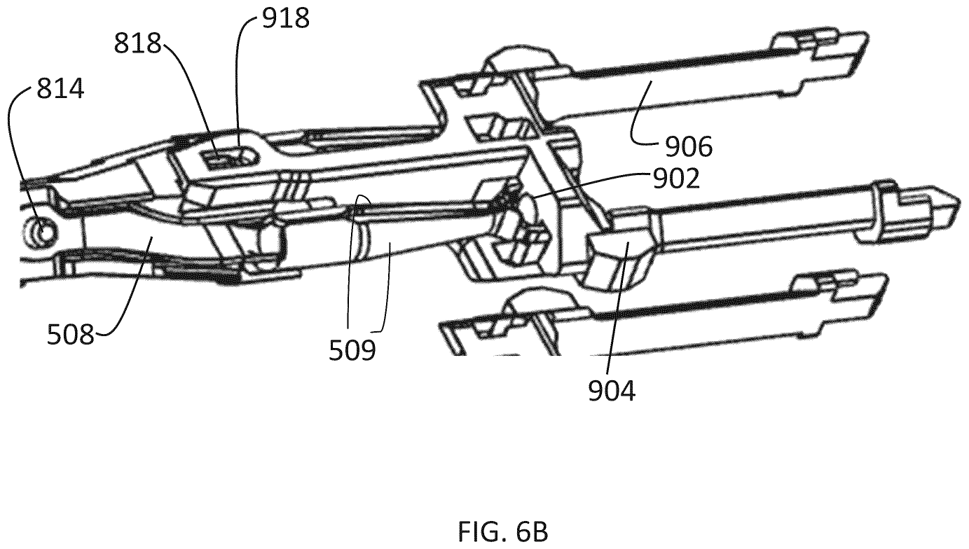

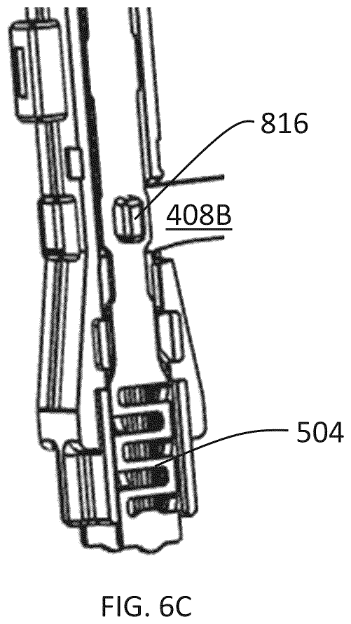

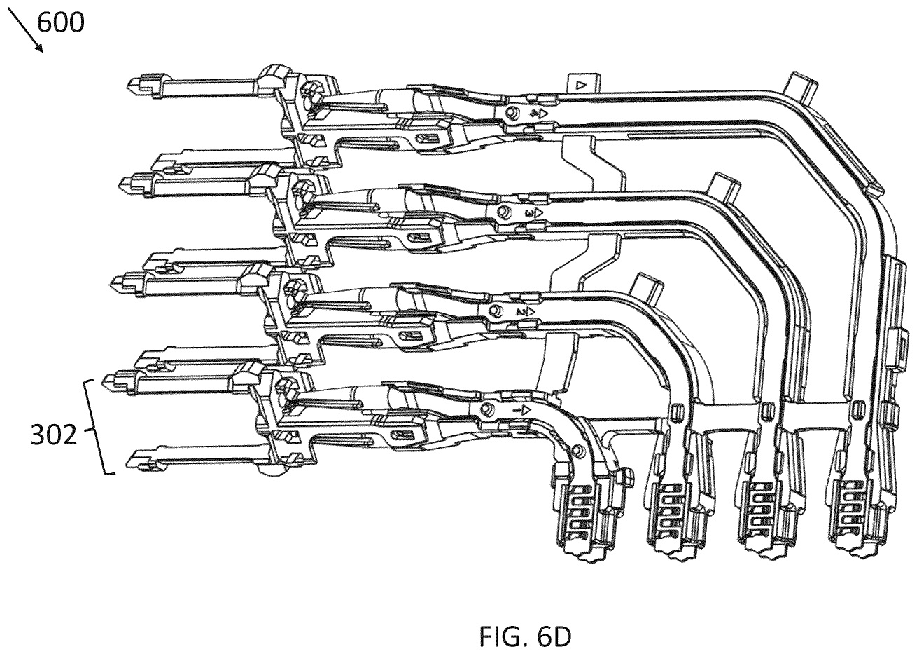

In FIG. 8A, inner insulative portions 802 include channels 812B for supporting signal conductors, which may include elongated projections 810 on either side of where the signal conductors are supported (see FIG. 6A). Similarly, mating end portions 824 may include channels 822A and 822B mating ends 502.

FIG. 10 shows the outer insulative members 1000A and 1000B (collectively, an outer insulative member assembly 1000).

Referring to FIG. 6A-6D, FIG. 6A shows a wafer subassembly 600, with conductive structures forming electromagnetic shields and outer insulative portions removed. Signal conductors inserted into channels (812A, FIG. 8A; 812B, FIG. 8B) in the inner portion of the insulator are exposed in this view. In this example, mating ends 502 of signal conductors 500 include compliant receptacles, each having mating arms 509. In the illustrated example, compliant receptacles are configured to receive and make contact with a mating portion of a signal conductor of a mating connector between mating arms. For example, a mating portion of a mating connector, such as a pin, may be received through an aperture of insulative support to make contact with mating arms.

FIG. 6B shows a portion of the wafer subassembly labeled 6B in FIG. 6A. As can be seen in FIG. 6B, mating ends are formed by rolling conductive material of the sheet of metal from which signal conductors are formed into a generally tubular configuration. That material is rolled towards the centerline between mating ends. Such a configuration leaves a flat surface of the signal conductors facing outwards toward the shield members, which may aid in keeping a constant spacing between the signal conductors and the shield members, even in the twist region.

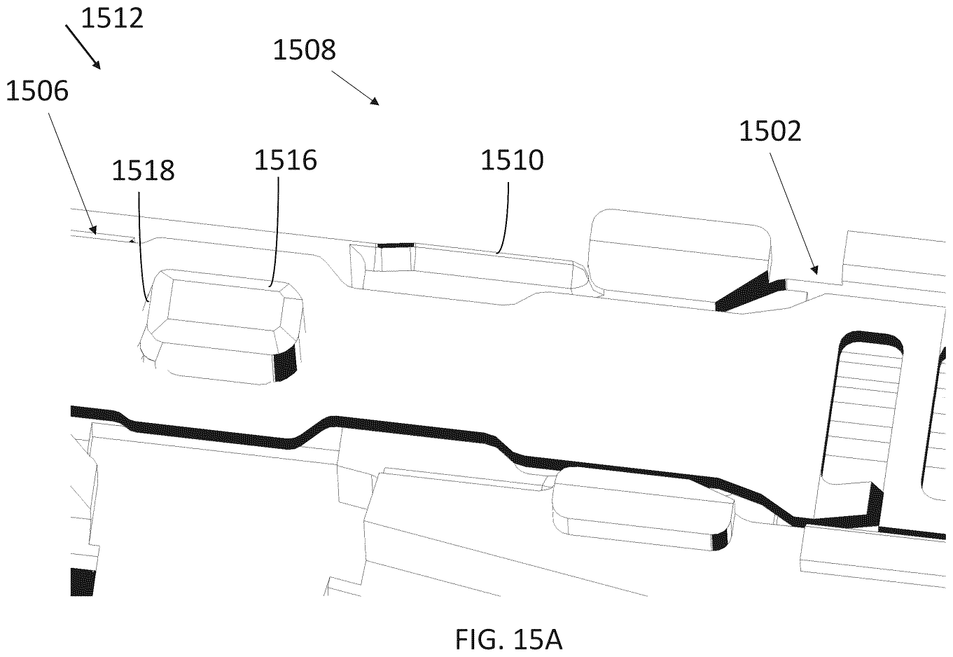

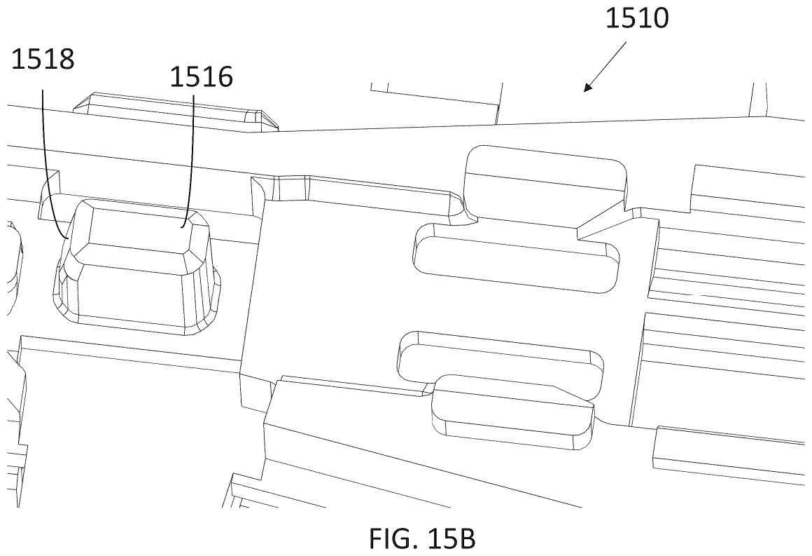

FIG. 6C shows a portion of the subassembly labeled 6C in FIG. 6A, including a portion of a signal conductor 500 terminating at a mounting end 504. The signal conductor 500 includes a hub 816 near the mounting end 504, as described further below in connection with FIGS. 15A-15B. Similar hubs 814 may be provided near the mating ends 502.

FIG. 6D shows an opposite side perspective view of the wafer subassembly of FIG. 6A.

It should be appreciated, that a spacing between signal conductors may be substantially constant in units of distance. Alternatively, the spacing may provide a substantially constant impedance. In such a scenario, for example, where the signal conductors are wider, such as a result of being rolled into tubes, the spacing relative to the shield may be adjusted to ensure that the impedance of the signal conductors is substantially constant.

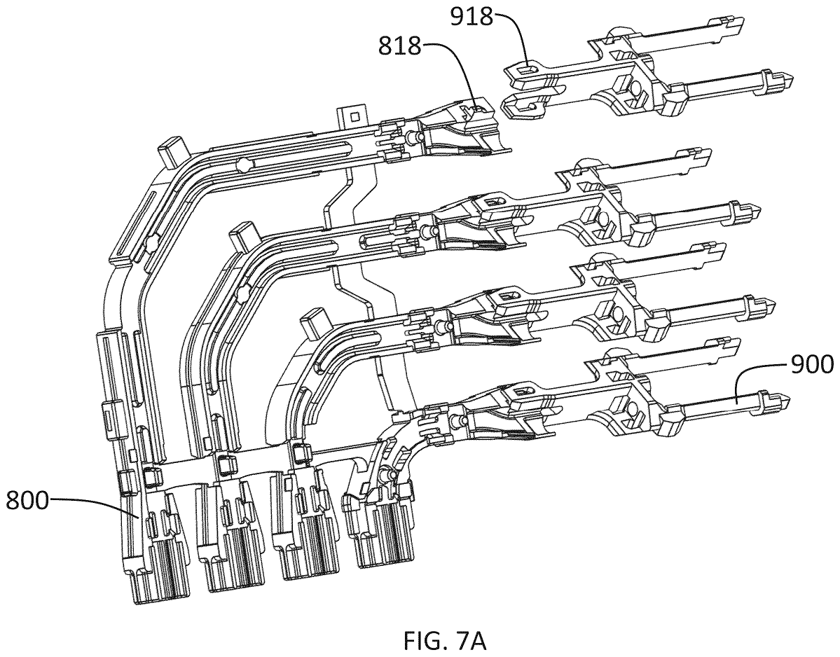

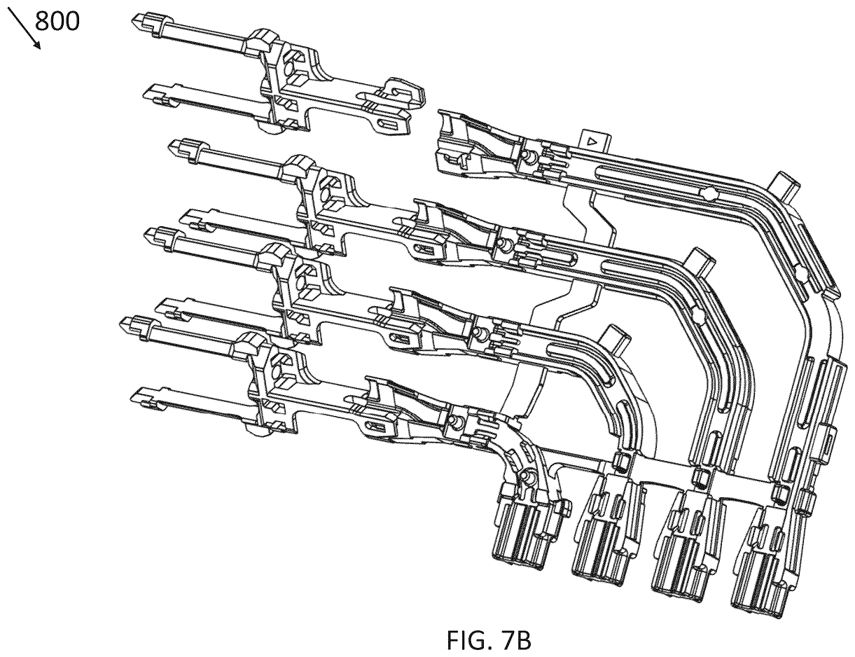

The inner portion of the insulator of a wafer subassembly may be formed of one or more components. In the example illustrated in FIGS. 7A-7B, an inner portion of the subassembly 300 is formed of five components that are molded separately and then combined to the inner portion of the subassembly 300. In the illustrated example, the inner portion is configured to form four signal units. The inner portion includes a first component (e.g., inner insulative member 800) with portions that hold signal conductors of all units in the wafer joined by bars. Second components (e.g., mating end insulative member 900), each to provide a desired insulative shape at the mating interface of the signal conductors of one unit, are attached to the first component. The configuration shown may facilitate manufacture of a dense connector.

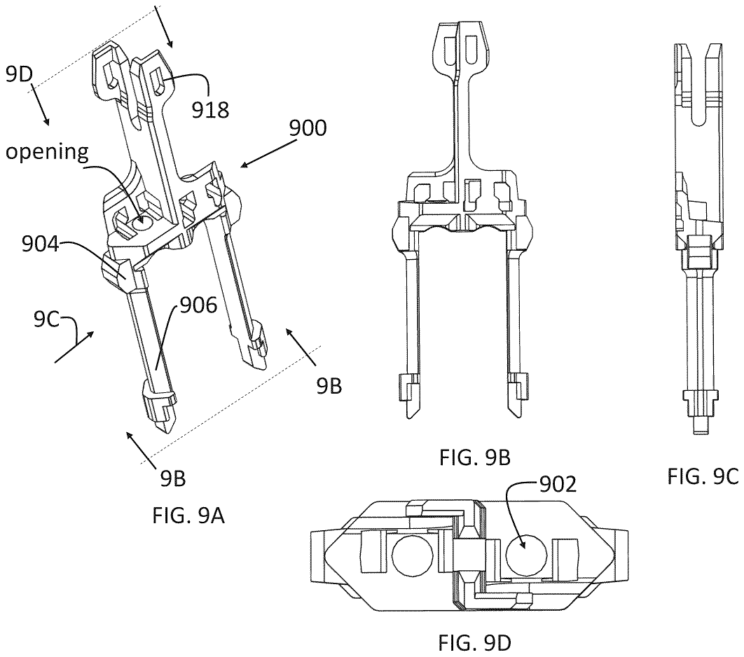

FIGS. 7A-7B show the inner insulative member 800 and mating end insulative members 900, with one of the mating end insulative member 900 disconnected from the inner insulative member 800. FIGS. 9A-9D further illustrate the mating end insulative member 900. As illustrated, each inner insulative portion 802 of the inner insulative member 800 may include a mating end insulative member 900 securely attached to the inner insulative member 800. Each inner insulative portion 802 may include protrusion 818 adjacent an end. The mating end insulative member 900 may include an opening 918 engaging the protrusion 818 of the inner insulative portion 802.

The mating end insulative member 900 may include one or more openings 902 through which a mating component can access the mating ends 502 of signal conductors 500. The mating end insulative member 900 may include one or more arms 906 which may be inserted into a mating component so as to guide mating ends of the mating component into the openings and/or enable impedance control upon mating/demating. The arm 906 may include a protrusion 904 that may extend out of the mating end portion 1104 of the conductive structures for a respective unit 302 through a gap 1128 between respective first side 1122 and second side 1124 of the mating end portion 1104 of the conductive structures for the respective unit 302 such that the mating end insulative member 900 is secured in the conductive structures for the respective unit 302.

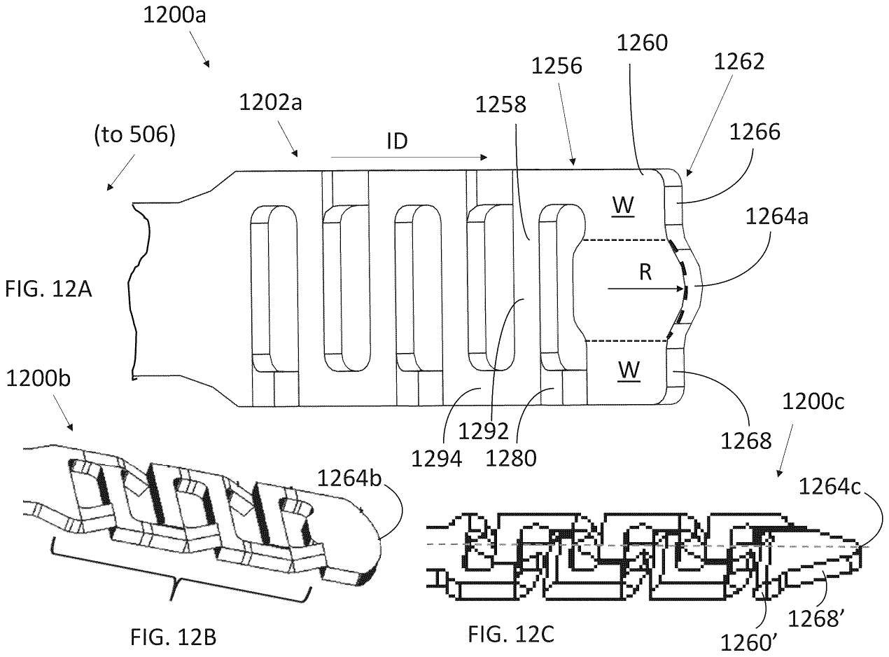

Referring to FIG. 12A, a contact tail 1200a is shown having a plurality of segments including a distal segment having wings and a rounded tip, in accordance with some embodiments.

In some embodiments, a pair of signal conductors (e.g., 500) of an electrical connector (e.g., 10) may include contact tails 1200a such as shown in FIG. 12A adapted for connection to a surface of a substrate (e.g., 1D) in an insertion direction. For example, the insertion direction, shown in FIG. 12A relative to the contact tail 1200a, may be transverse (e.g., normal) to the surface of the substrate when the connector is mounted to the substrate. Referring back to the example of FIG. 1D, the insertion direction may be parallel to the column direction 128.

In some embodiments, the electrical connector including the contact tails may further include a housing (e.g., 102, 106, wafers 100) and a plurality of conductive elements (e.g., 500) held within the housing and including the contact tails. For example, the conductive elements may further include mating contact portions (e.g., 502) and intermediate portions (e.g., 506), held within the housing, coupling the mating contact portions to the contact tails.

In some embodiments, the conductive elements may further include compliant portions that are coupled to and/or a part of the contact tails, allowing the contact tails to move with respect to other portions of the connector. For example, when the connector is not mounted to a substrate, the contact tails may extend from the housing at a mounting face (e.g., adjacent the substrate in FIG. 1D), and the compliant portions may be movable with respect to the housing in a direction (e.g., the insertion direction) perpendicular to the mounting face.

In the illustrated embodiment, a compliant portion 1202a coupled to the contact tail 1200a has a plurality of segments spaced from one another in the insertion direction and includes a first segment spaced from another segment of the plurality of segments in the insertion direction. For example, in FIG. 12A, the illustrated contact tail 1200a has an end segment 1260 at a distal end of the of the segments in the insertion direction and is spaced from, and directly adjacent to, a second segment 1258 of the segments in the insertion direction.

In some embodiments, a contact tail may include an edge at the mounting face facing in the insertion direction (e.g., mounting edge). The mounting edge may have multiple portions, one of which may be rounded and may form a tip having a first radius of curvature. One or more other portions may have a second radius of curvature larger than the first radius of curvature. These portions may be directly adjacent the rounded tip. For example, as shown in FIG. 12A, the mounting edge 1262 of the contact tail has a rounded tip 1264a with radius of curvature R and edge portions 1266, 1268 directly adjacent the rounded tip 1264a that are substantially flat (e.g., with substantially zero radius of curvature). It should be appreciated that the edge portions need not be substantially flat as they may have some curvature of radius smaller than R in other embodiments. It should also be appreciated that a mounting edge portion may be provided on only one side of the rounded tip in some embodiments.

In some embodiments, the rounded tip may protrude in the insertion direction and be configured to apply pressure to a surface of a substrate. For example, the radius of curvature of the rounded tip may be configured to localize force applied by the contact tail during mounting onto a region of a contact pad on the surface of the substrate to create a pressure mount contact. For instance, the amount of pressure may be sufficient to remove at least enough oxide or other contaminants from the contact pad to form a hermetic seal, and/or to at least remove contaminants from the contact pad sufficient to form a low resistance connection between the contact pad and the rounded tip.

In some embodiments, the rounded tip may have a radius R between 0.1 mm and 0.2 mm, such as between 0.125 mm and 0.175 mm, between 0.14 mm and 0.16 mm, and/or 0.15 mm.

Alternatively or additionally, the contact tail may be shaped to provide a desired impedance profile along the contact tail, which may include an impedance that is the same as the impedance of other portions of the conductive elements or, when averaged with the impedance through the transition into the substrate, matches that impedance. In the illustrated example, a desired impedance is provided with wings W on either side of the rounded tip 1264a. As shown in FIG. 12A, the contact tail 1200a may include wings W alongside the rounded tip 1264a (e.g., including the mounting edge portions) and configured to tune an impedance of the contact tail 1200a, such as to reduce impedance in a region where the contact tail 1200a engages a contact pad on the surface of the substrate. For example, the wings W may be configured to increase capacitance of the contact tail to tune the impedance.

For instance, in FIG. 12A, the contact tail 1200a has broad sides and edges (e.g., lateral edges 1256) that are narrower than the broad sides, the wings W are at the edges of the contact tail, and the rounded tip is between the wings along the broad sides. In the illustrated embodiment, the wings W make the distal end of the contact tail wider (e.g., from one lateral edge to the other) than if only the rounded tip 1264a were present, resulting in a larger capacitance. In the illustrated embodiment, the wings W are directly adjacent the rounded tip with no other portion of the contact tail 1200a therebetween.

The inventors have recognized that a contact tail with a rounded tip and wings may provide a desirable amount of pressure on a contact pad while providing a low impedance. For example, by contrast, the contact tail 1200b shown in FIG. 12B has a rounded tip 1264b without wings, as the rounded tip 1264b occupies the entire mounting edge of the contact tail 1200b. The rounded tip 1264a shown in FIG. 12B also has a larger radius of curvature than the contact tail 1200a of FIG. 12A. Consequently, the contact tail 1200b shown in FIG. 12B applies force over a larger area of a contact pad than the contact tail 1200a of FIG. 12A, resulting in less pressure than the contact tail 1200a of FIG. 12A.

In contrast, the contact tail 1200c shown in FIG. 12C does not include a rounded tip but rather includes a sharp tip 1264c. Consequently, the contact tail 1200c shown in FIG. 12C applies force over a smaller area of a contact pad than the contact tail 1200a of FIG. 12A, resulting in potentially too much pressure for some applications (e.g., causing cracking of some contact pads), and making the point of contact with a pad more sensitive to motion and/or rotation of the contact tail than in FIG. 12A. Moreover, the narrow point of contact provided by the sharp tip 1264c of the contact tail 1200c of FIG. 12C and the elongated sections 1268′ of the mounting edge between the sharp tip 1264c and the lateral edges of the last segment 1260′ result in a higher contact impedance than the contact tail 1200a of FIG. 12A.

The compliant portion may be compressible in the insertion direction. For example, the plurality of segments may be configured to compress along the insertion direction when the rounded tip is pressed against the surface of the substrate in the insertion direction. For instance, the segments (e.g., 1258) are shown in FIG. 12A having fingers (e.g., 1280) that may guide the segments to twist when the compliant portion 1202a is compressed in the insertion direction. The segments may be configured to generate a spring force along the insertion direction when compressed, which may press the distal end of the contact tail 1200a against a substrate for mounting.

Further, pressing each segment of the compliant portion against a finger of an adjacent segment may create conductive paths on opposing sides of the compliant portion. The inventors have recognized and appreciated that techniques as described herein may increase the reliability of connections between the fingers and the segments of the compliant portion, which can improve high frequency performance of the connector. If one or more of the segments does not form a suitable connection, the current paths through the compliant portion may be altered, which in turn may degrade high frequency performance. For example, distributing rotation along the length of the compliant portion as described herein may increase the reliability of connections along the length of the compliant portion.

Alternatively or additionally, the compliant portion may be made of a metal alloy and/or may include plating or other coating that enhances the connection between the segments and the fingers. Optionally, the contact tail may include copper titanium (Cu—Ti), such as in the compliant portion. For example, a base metal of the compliant portion may include a Cu—Ti alloy. The inventors have recognized and appreciated that Cu—Ti may provide a desirable spring force in a small contact tail. In some examples, that spring force may be achieved without necessarily requiring heat treatment, thereby improving manufacturability of the contact tail.

In some embodiments, the rounded tip may include plating that is more conductive than Cu—Ti. For example, the rounded tip may include gold plating. The inventors have recognized that Cu—Ti may be leveraged to provide a desirable spring force for the contact tail while a more conductive material, such as gold, may be used in the tip of the contact tail for a low impedance interface with a contact pad on a substrate. Optionally, the plating may be applied to the fingers and/or at least the regions of the compliant portions that engage the fingers.

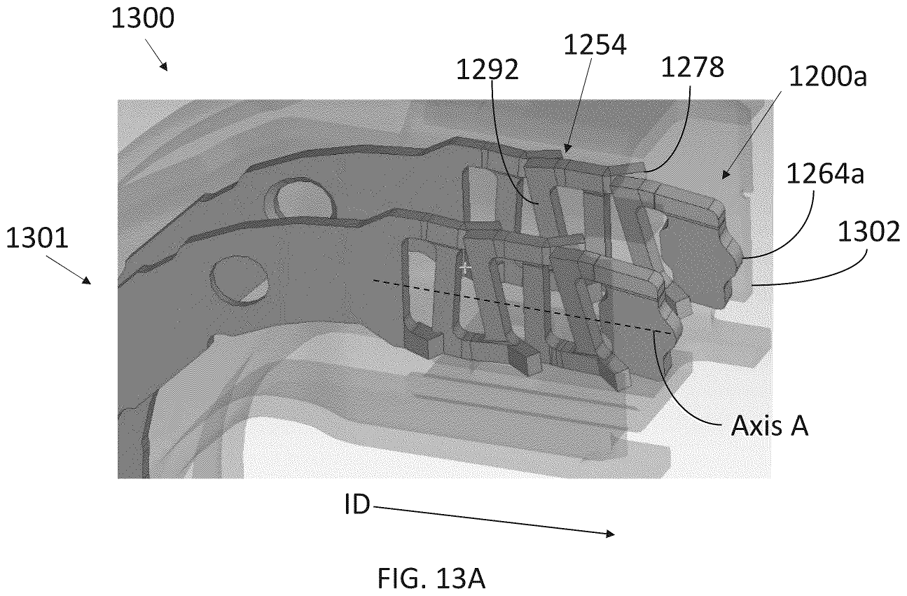

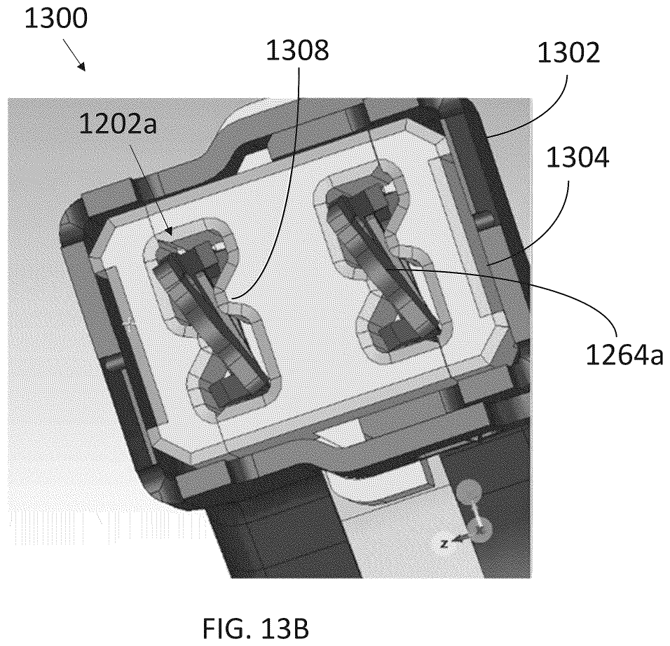

Referring to FIGS. 13A-13B, a unit 1300 including a pair of intermediate portions 1301 and contact tails 1200a of FIG. 12A are shown having segments compressed along an axis about which the segments have rotated, in accordance with some embodiments.

In some embodiments, the plurality of segments of the contact tail may be configured to rotate about an axis parallel to the insertion direction when compressed. For example, as shown in FIG. 13A, the segments (e.g., 1254) of the pair of contact tails 1200a are rotated about the axis A, and the axis A is shown parallel to the insertion direction ID. In some embodiments, the fingers of the compliant portion may be configured to translate compression along the insertion direction into rotational motion about the axis. For example, in FIGS. 12A and 13A, the fingers (e.g., 1278, 1280) are angled with respect to the insertion direction ID, and the segments are elongated in a direction perpendicular to the insertion direction ID. For instance, in the illustrated embodiment, compressing the segments moves the segments closer to one another along the insertion direction. And, as shown in FIG. 13A, the plurality of segments are configured to ride along the fingers between adjacent segments to rotate about the axis A when compressed. As shown in FIGS. 12A and 13A, each segment includes a rung (e.g., 1292 extending transverse to the insertion direction ID when uncompressed) and a rail (e.g., 1294, FIG. 12A, extending parallel to the insertion direction ID when uncompressed) from which the rung extends. For instance, the rungs may be configured to ride along the fingers, which may cause the rungs to rotate relative to one another.

In some embodiments, the electrical connector may include housing features configured to control rotation of the signal conductors. For example, as shown in FIG. 13B, an insulative member 1304 supporting the pair of signal conductors includes projections 1308 configured to control rotation of the contact tails about the axis. For instance, as shown in FIG. 13B, the projections 1308 are positioned in the path of rotation of the contact tails 1200a about the axis A to impede rotation of the contact tails 1200a beyond the points at which the contact tails 1200a meet the projections.

In some embodiments, the electrical connector may include electromagnetic shielding (e.g., conductive members 1102A, 1102B) for the pair of signal conductors extending alongside the contact tails. For example, as shown in FIG. 13B, a pair of conductive members 1302 extends alongside the contact tails 1200a in the insertion direction ID to provide shielding at the mounting interface. In the illustrated embodiment, the conductive members 1302 are buckled around the contact tails 1200a and may be welded together.

In some embodiments, the electromagnetic shielding may include structures configured to secure the connector to the substrate against the spring force generated by the contact tails, permanently and/or at least until the connector may be additionally fastened to the substrate. Although not shown in FIG. 13B, an example of such a structure is a press fit tail. For instance, press fit tails may be included on opposite sides of the contact tails such as shown, e.g., in FIG. 3A.

In some embodiments, the electromagnetic shielding may bound the contact tails along a perimeter extending 360 degrees around the contact tails. For example, in FIG. 13B, electromagnetic shielding is shown on all four rectangular sides of the contact tails. In some embodiments, there may be gaps in the electromagnetic shielding along the perimeter (e.g., electromagnetically small gaps), whereas in other embodiments the perimeter may be entirely closed.

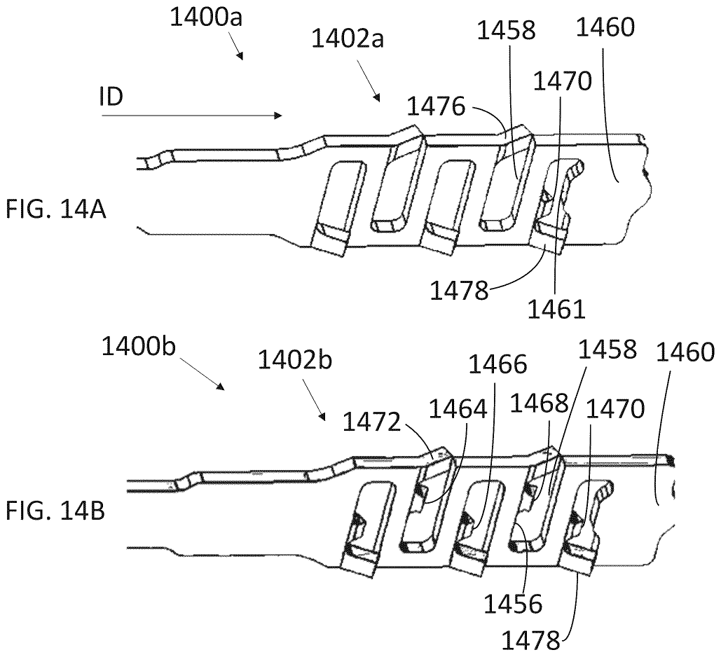

Referring to FIGS. 14A-14B, contact tails 1400a, 1400b are shown having a tab between adjacent segments configured to limit movement of segments of the contact tails. The inventors have recognized that limiting movement of segments of the contact tails may promote more uniform movement of the segments when compressed, such as by preventing greater rotation of some segments with respect to other segments as compressive force is translated into rotation of the segments. More uniform movement of the segments may, in turn, improve the signal integrity of signals carried by the contact tails. As one example, more uniform movement of the segments may ensure that adjacent segments contact one another and create a conductive path therebetween, resulting in a favorable impedance at the contact tail. As another example, geometry of the conductive path carrying the signals may change gradually rather than abruptly. Moreover, the geometries of the conductive paths of a pair of contact tails (e.g., carrying a differential signal) may change similarly to one another.

In some embodiments, the contact tails 1400a, 1400b shown in FIGS. 14A and 14B may be configured as described herein for the contact tail 1200a of FIG. 12A and may be incorporated into an electrical connector as described herein in the same manner as the contact tail 1200a of FIG. 12A. As shown in FIGS. 14A and 14B, the illustrated contact tails 1400a, 1400b are configured to limit movement of some segments relative to other segments. For example, in FIG. 14A, the second segment 1458 includes a tab 1470 protruding towards the end segment 1460 of the compliant portion 1402a, which may be configured to limit movement of the end segment 1460 and the second segment 1458 toward one another when the segments 1460, 1458 are compressed. For instance, when the end segment 1460 moves toward the second segment 1458 as the end segment 1460 rotates, the tab 1470 may contact the end segment 1460 to limit rotation and further movement of the end segment 1460. In the illustrated embodiment, the tab 1470 protrudes from the second segment 1458 towards the end segment 1460 in a direction that is acute with respect to the insertion direction ID and the end segment 1460 has an edge 1461 projected towards the second segment 1458 along the insertion direction ID.

In some embodiments, the first tab 1470 may be rigidly connected to the second segment 1458, such as by having a large area of physical connection to the segment 1458 and/or by protruding only a short distance from the segment 1458 so as to not bend when pressed by another segment. In some embodiments, a tab may be between 1-5 mils thick, such as 2-4 mils, and/or 3 mils thick.

In some embodiments, a segment having a tab may further include a finger, with the finger and the tab protruding from the segment in different directions transverse to the insertion direction. For example, in FIG. 14A, the finger 1478 and the tab 1470 protrude in different directions from the second segment 1458, with both directions being acute with respect to the insertion direction ID. For instance, in the illustrated embodiment, the finger 1478 may be configured to guide rotation of the end segment 1460, which may align the rung of the end segment 1460 with a distal tip of the tab 1470 when the end segment 1460 meets the tab 1470. In some embodiments, the tab 1470 may be positioned between fingers of the compliant portion in a direction transverse (e.g., perpendicular) to the insertion direction. For example, in FIG. 14A, the tab 1470 is between the finger 1478 of the second segment 1458 and the finger 1476 of the prior segment in the direction separating the lateral edges of the contact tail 1400a.

In some embodiments, a contact tail may include multiple tabs, such as shown in FIG. 14B. For example, in FIG. 14B, the compliant portion 1402b of the contact tail 1400b includes a first tab 1470 protruding from the second segment 1458 towards the end segment 1460 as in FIG. 14A, and the contact tail 1400b further includes a second tab 1468 protruding from a prior segment 1456 (e.g., along the insertion direction) towards the second segment 1458. For instance, the second tab 1468 may be configured to limit movement of the prior segment 1456 and the second segment 1458 relative to one another when compressed, such as described herein for the first tab 1470. In the illustrated embodiment, a tab 1464, 1468, 1470 protrudes from each segment, though it should be appreciated that any number of segments may have or may not have a tab protruding therefrom according to various embodiments.

In some embodiments, tabs of the contact tail may be offset from one another in a direction transverse (e.g., perpendicular) to the insertion direction. For example, in FIG. 14B, the first tab 1470 and the second tab 1468 are offset from one another in the direction separating the lateral edges of the contact tail. In the illustrated embodiment, the tabs 1464, 1466, 1468, 1470 of the compliant portion alternate along the insertion direction ID between a first position and a second position along a direction transverse to the insertion direction ID (e.g., the direction separating the lateral edges of the contact tails). It should be appreciated that some or all tabs may not alternate as shown, and/or that more than two tab positions may be used along a direction transverse to the insertion direction.

In some embodiments, each tab of the contact tail may be positioned between a respective pair of fingers in a direction transverse to the insertion direction. For example, in FIG. 14B, each tab 1464, 1466, 1468 is positioned between a respective pair of fingers (e.g., 1472, 1478) of the compliant portion in the direction separating the lateral edges of the contact tail. In the illustrated embodiment, each tab 1464, 1466, 1468, 1470 protrudes from a segment in a same direction, transverse (e.g., acute) to the insertion direction ID, as a first of the respective pair of fingers (e.g., 1472) and in an opposite direction, transverse (e.g., acute) to the insertion direction ID, as a second of the respective pair of fingers (e.g., 1478). In some embodiments, the tab(s) and fingers may work together to translate compression into rotation and limit rotation. For example, a finger may push a segment in a direction perpendicular to the insertion direction (e.g., generating rotation about the axis), and a tab may limit how far that segment can move transversely with respect to the insertion direction (e.g., limiting rotation about the axis). In this example, when the segment engages the tab, further rotation of the segment may require additional force sufficient to also rotate the segment from which the tab projects, thereby distributing force (e.g., and rotation into which the force is translated) along the length of the compliant portion.

In some embodiments, rotation of at least some segments of a contact tail may be limited to 4 degrees or less with respect to the next segment. For example, a first segment may be configured to limit rotation of a second segment with respect to the first segment to 4 degrees or less when the first segment and a third segment are compressed towards one another along the insertion direction. For instance, in FIG. 14A, the second segment 1458 may be configured to limit rotation of the prior segment 1456 (along the insertion direction) with respect to the second segment 1458 when the second segment 1458 and the end segment 1460 are compressed towards one another along the insertion direction ID. In the illustrated embodiment, rotation is limited using the tab 1470 protruding from the second segment 1458, which limits movement of the end segment 1460 towards the second segment 1458 in a direction transverse to the insertion direction ID and/or rotationally about the axis A. This may prevent significant disparities between rotation of the end segment relative to the second segment 1458 and rotation of other segments relative to prior segments, thereby producing a gradual rotation of the segments along the insertion direction ID when the compliant portion is compressed, which improves the signal integrity of signals carried by the contact tails.

In some examples, the first segment may be configured to limit rotation of the second segment about the axis with respect to the first segment beyond 3.5 degrees, 3.3 degrees, 3 degrees, and/or beyond 2.5 degrees, when the first segment and the third segment are compressed toward one another along the insertion direction. In some embodiments, a segment may be configured to rotate at least 2 degrees with respect to another segment when the plurality of segments are compressed along the insertion direction. For example, rotation of at least some segments may be at least 2 degrees whereas rotation of at least some segments may be limited to 4 degrees, 3.5 degrees, 3.3 degrees, 3 degrees, and/or 2.5 degrees or less.

In some embodiments, the segments may be configured to rotate at least 20 degrees about an axis parallel to the insertion direction when compressed along the insertion direction. For example, the segments may be configured to rotate at least 20 degrees from a first end segment along the insertion direction to a second end segment along the insertion direction when compressed along the insertion direction. For instance, the at least 20 degrees of rotation may be distributed substantially evenly among the segments, such as with 4 or 5 segments rotated no more than 4 degrees each with respect to the next segment, respectively. Alternatively or additionally, in some embodiments, the segments may be configured to rotate about the axis at least 6 degrees per mm of length of the segments in the insertion direction. For example, the total rotation of the segments (e.g., 24 degrees) may be divided over the length of the segments (e.g., 1.5 mm) to obtain the rotation per mm of length.

In some embodiments, rotation of the segments by at least 20 degrees may be for a subset of segments of the compliant portion. For example, the subset of segments may be connected between a first end segment of the plurality of segments along the insertion direction and a second end segment of the plurality of segments along the insertion direction, and each segment of the subset may be configured to limit rotation of the segment with respect to another (e.g., an adjacent) segment beyond 4 degrees, 3.5 degrees 3.3 degrees, and/or 3 degrees when the segment and the other segment are compressed toward one another along the insertion direction. In some embodiments, the subset of segments may include each segment of the plurality of segments that is not configured to contact the surface of the substrate. For example, the end segment, which is configured to contact a pad on a substrate, may be configured to rotate farther with respect to the second segment than for other segments. For instance, a contact tail may rotate 22-25 degrees over its length, with 14-16 degrees (e.g., 15 degrees) of rotation of the end segment relative to the second segment and with 7-10 degrees of rotation over the remaining segments, which may result in 2.3 to 3.3 degrees in some cases, and/or 1.75 to 2.5 degrees of rotation per segment in other cases.

In some cases, the length of the contact tail may be between 1.5 mm and 2 mm, between 1.5 mm and 1.6 mm, between 1.6 mm and 1.8 mm, such as 1.7 mm or 1.65 mm, with the length of the end segment being between 0.2 mm and 0.3 mm such as 0.285 mm, and/or between 0.25 mm and 0.35 mm such as 0.335 mm, and the length of the segments up to the end segment being between 1.3 mm and 1.4 mm, such as 1.365 mm, with each segment being between 0.25 mm and 0.3 mm, such as 0.28 mm. For example, where a contact tail has a length of 1.65 mm, a length of the end segment being 0.285 mm, and the length of 4 segments up to the end segment being 1.365 mm, the end segment may be configured to rotate 15 degrees relative to the second segment, and the other segments may be configured to rotate no more than 10 degrees, collectively, resulting in 2.5 degrees of rotation per segment with respect to the next segment. Similarly, where a contact tail has a length of 1.7 mm, a length of the end segment being 0.335 mm, and the length of 4 segments up to the end segment being 1.365 mm, the end segment may be configured to rotate 15 degrees relative to the second segment, and the other segments may be configured to rotate no more than 10 degrees, collectively, resulting in 2.5 degrees of rotation per segment with respect to the next segment. In another case, where a contact tail has a length of 1.7 mm, a length of the end segment being 0.335 mm, and the length of 3 segments up to the end segment being 1.365 mm, the end segment may be configured to rotate 15 degrees relative to the second segment, and the other segments may be configured to rotate no more than 10 degrees, collectively, resulting in 3.3 degrees of rotation per segment with respect to the next segment.

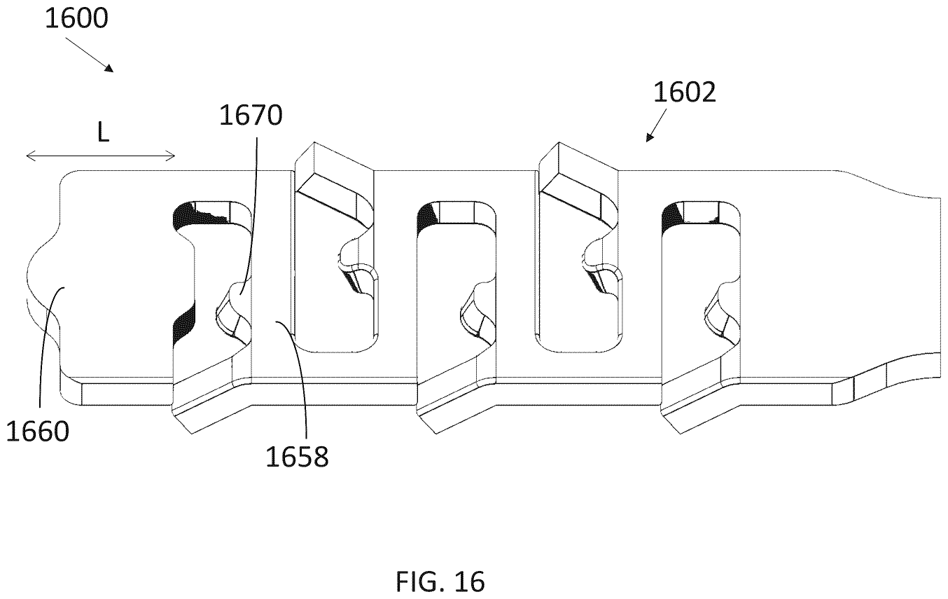

FIG. 16 is a perspective view of an alternative embodiment of the contact tail of FIG. 14B having tabs with rounded edges between each pair of segments of the compliant portion, according to some embodiments.

In some embodiments, the contact tail 1600 of FIG. 16 may be configured as described herein for the contact tail 1400b of FIG. 14B. For example, as shown in FIG. 16, the contact tail 1600 has multiple tabs (e.g., 1670) between adjacent segments (e.g., 1660, 1658) such as described in connection with FIG. 14B. In the illustrated example of FIG. 16, the tabs (e.g., 1670) have rounded edges. For instance, the rounded edges may be configured to provide control over the contact surface and range of contact angles. It should be appreciated that squared edges such as shown in FIGS. 14A-14B may be so controlled in some embodiments as well.

In some embodiments, the contact tail 1600 shown in FIG. 16 may have a different length than the contact tail 1400b of FIG. 14B. For example, the distal segment 1660 of the contact tail 1600 of FIG. 16 may have a different length than the distal segment 1460 of the contact tail 1400b of FIG. 14B. For instance, the distal segment 1660 of the contact tail 1600 of FIG. 16 may be longer than the distal segment 1460 of the contact tail 1400b of FIG. 14B, and the lengths of the contact tails 1600, 1400b may be otherwise equal. In some embodiments, the distal segment 1460 of the contact tail 1400b of FIG. 14B may have a length of 0.285 mm whereas the distal segment 1660 of the contact tail 1600 of FIG. 16 may have a length L between 0.3 mm and 0.4 mm, such as 0.335 mm. The longer length of the distal segment 1660 of the contact tail 1600 of FIG. 16 may result in a greater compression of the compliant portion 1602 when mounting to a contact pad, which in turn may bring the segments at the opposite ends of the distal segment into closer contact with one another than where the distal segment is shorter.

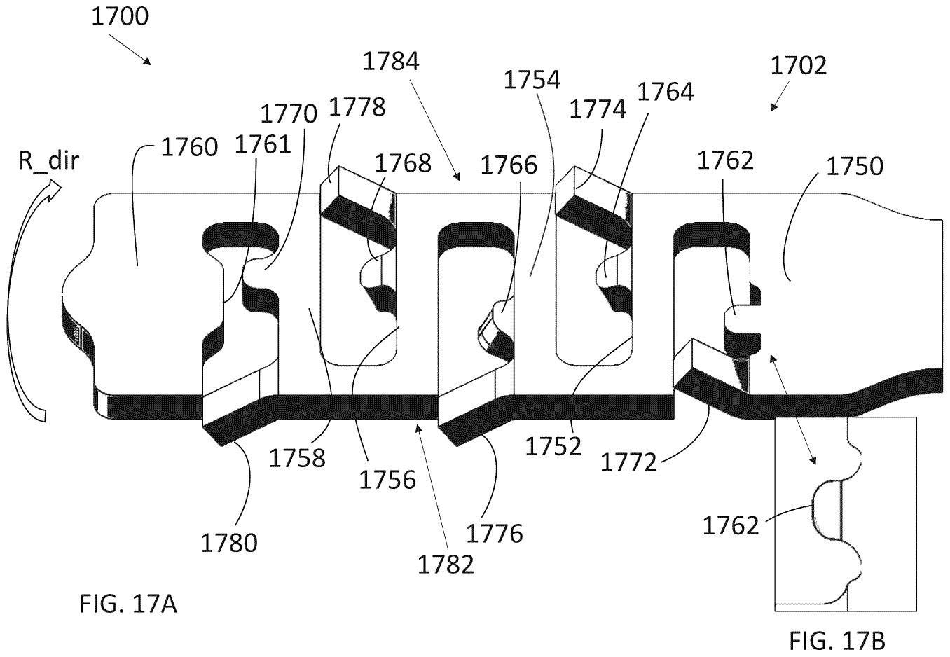

In some embodiments, a contact tail may have fingers along the same edge that are angled in different respective directions with respect to the insertion direction and/or fingers along opposite edges of the contact tail that are angled in the same direction with respect to the insertion direction, an example of which is described herein in connection with FIG. 17A. Such configurations may add further control over rotation of the contact tail to increase certainty that contact between segments of the contact tail will occur over a range of operating conditions that might be experienced.

FIG. 17A is a perspective view of an alternative embodiment of the contact tail of FIG. 16 having fingers 1772, 1776 along an edge 1782 of the contact tail angled in different respective directions with respect to the insertion direction, according to some embodiments. Fingers 1772 and 1776, for example, are along the same edge 1782 and angled in different respective directions. In the illustrated example, finger 1772 is angled up and finger 1776 is angled down. In this example, the finger 1772 most proximal to the interface between the compliant portion 1702 and the upper portion (e.g., base 1750) of the contact tail 1700 is angled in an opposite direction from the other fingers on the same edge of the contact tail 1700. FIG. 17B is an enlarged view of a tab 1762 recessed into the contact tail 1700 of FIG. 17A.

In some embodiments, the contact tail 1700 of FIG. 17A may be configured as described herein for the contact tail 1600 of FIG. 16. For example, as shown in FIG. 17A, the contact tail 1700 includes fingers 1772, 1774, 1776, 1778, and 1780 and tabs 1762, 1764, 1766, 1768, and 1770 between adjacent segments 1752, 1754, 1756, 1758, and 1760 of the contact tail 1700. For instance, the contact tail has a first tab 1770 that protrudes from segment 1758 toward the distal segment 1760 of the contact tail, and the distal segment 1760 has an edge 1761 projected towards segment 1758 along the insertion direction. Moreover, as described herein for the contact tails of FIGS. 12A-14B and 16, the fingers 1774, 1776, 1778, and 1780 may be configured to ensure contact between segments 1752, 1754, 1756, 1758, and 1760 when the contact tail is compressed. Some or all of the fingers (e.g., 1774, 1776, 1778, and 1780) may be configured to translate compression of the segments along the insertion direction into rotational motion about an axis that is parallel to the insertion direction, and/or some or all of the fingers (e.g., 1772, 1774, 1776, 1778, and 1780) may be configured to translate compression of the segments along the insertion direction into a spring force along the insertion direction. In the illustrated example, the tab 1770 protrudes from segment 1758 in a different direction than finger 1780 protrudes from segment 1758.

In some embodiments, some fingers of the contact tail may be configured to translate compression of the segments into rotation about an axis parallel to the insertion axis, and some fingers of the contact tail may be configured to contact the segments that have rotated. For example, in FIG. 17A, finger 1774 may be configured to translate compression of segments 1752 and 1754 into rotation of segment 1752 in a first rotational direction R_dir, and finger 1772 may be configured to contact segment 1752 when segment 1752 rotates in the first rotational direction R_dir. For instance, having fingers (e.g., 1774, 1776, 1778, and 1780) that extend in opposite directions on opposite edges 1782, 1784 may impart rotational motion to a segment of the contact tail when compressed, and further having a second finger (e.g., 1772) that extends in a same direction as a first finger (e.g., 1774) on the opposite edge 1784 may place the second finger in the path of rotation of the segment. The inventors have recognized that having some fingers configured to impart rotational motion to the contact tail while another finger or fingers are configured to contact the rotated portion of the contact tail, such as shown in the example of FIG. 17A, may help ensure electrical contact is made between the compliant portion 1702 and the base 1750 at which the compliant portion interfaces with other parts of the contact tail over a range of operating conditions. In the illustrated example,

In some embodiments, finger 1772 may be configured to interfere with rotation of segment 1752 in the first rotational direction R_dir. In the illustrated example of FIG. 17A, fingers 1772 and 1774 are angled in the same direction with respect to the insertion direction, which may place finger 1772 in the path of rotation of segment 1752 when compressed, resulting in interference that helps to establish electrical contact therebetween.

In some embodiments, fingers of the contact tail may extend along first and second opposite edges of the contact tail, and fingers that extend along the first edge may be angled in different respective directions with respect to the insertion direction. For example, in FIG. 17A, fingers 1772 and 1776 extend along a first edge 1782 of the contact tail 1700, with finger 1772 angled in a first direction with respect to the insertion direction and finger 1776 angled in a second direction with respect to the insertion direction that is opposite to the first direction. As further shown in the configuration of FIG. 17A, a subset of the fingers 1772, 1776, and 1780 extending along the first edge 1782 of the contact tail 1700 may extend in an opposite directions with respect to the insertion direction in comparison to the fingers 1774 and 1778 along the second, opposite edge 1784. Also shown in the configuration of FIG. 17A, finger 1774 extends along a second edge 1784 of the contact tail 1700 opposite the first edge 1782 and is angled in the first direction with respect to the insertion direction, like the finger 1772. In the illustrated example of FIG. 17A, the first and second edges both extend in the insertion direction.

The inventors have recognized that having fingers on a same edge of the contact tail angled in different respective directions and/or fingers on opposite edges of the contact tail angled in the same direction, such as shown in the example of FIG. 17A, may help ensure electrical contact is made between the compliant portion 1702 and the base 1750 where the compliant portion 1702 interfaces with other parts of the contact tail 1700 over a range of operating conditions. For example, under some operating conditions, when the contact tail 1700 of FIG. 17A is compressed such that segments 1754, 1756, 1758, and 1760 ride along corresponding fingers 1774, 1776, 1778, and 1780, segment 1752 from may rotate away from finger 1772. Having finger 1772 angled in the same direction as finger 1774 and/or in an opposite direction from finger 1776 may compensate for segment 1752 pulling away and thus reduce the amount of compression needed for segment 1752 to make contact with finger 1772.

In some embodiments, the contact tail may have multiple fingers along the second edge angled in the first direction. For example, as shown in FIG. 17A, finger 1778 extends along the second edge 1784 and is angled in the first direction with respect to the insertion direction. In some embodiments, fingers of the contact tail on the first and second opposite edges may be angled in the first and second opposite directions, respectively, with the exception of finger 1772. For example, in FIG. 17A, finger 1772 is the only finger extending along the first edge 1782 that is angled in the first direction rather than the second direction, and all fingers 1774 and 1778 extending along the second edge 1784 are angled in the first direction.

In some embodiments, the tabs of the contact tail may include a tab that protrudes from a respective segment in the insertion direction. For example, in FIG. 17A, tab 1770 protrudes from segment 1758 towards distal segment 1760 in the insertion direction. The inventors have recognized that rotation of the segments when compressed may bring some of the tabs into contact with the insulative member that supports the contact tail (e.g., to control rotation), which may interfere with the desired rotation of the contact tail. In some embodiments, by having a tab (e.g., 1770 and/or 1762) protrude along the insertion direction, the tab may be less likely to contact the insulative member when the segments rotate, thereby reducing or eliminating such interference with the insulative member.

As further shown in FIGS. 17A-17B, tab 1762 of the contact tail 1700, which is farthest from distal segment 1760 and closest to base 1750 may alternatively or additionally protrude in the insertion direction. In the illustrated example, tab 1762 may be recessed into base 1750 from which it protrudes, which may further increase the extent to which segment 1752 can move before contacting tab 1762. In some embodiments, base 1750 be configured as a stationary portion of the contact tail 1700 with respect to which the compliant portion 1702 is configured to rotate when compressed to generate a spring force.

In some embodiments, similar to the contact tails of FIGS. 14B and 16, the tabs of the contact tail may include tabs that protrude from respective segments in the first direction and/or the second direction. For example, in FIG. 17A, tab 1766 protrudes from segment 1754 in the first direction and tabs 1764 and 1768 protrude from respective segments 1752 and 1756 in the second direction.

In some embodiments, at least some of the tabs may alternate along the insertion direction between a first position and a second position that is offset from the first position in a third direction perpendicular to the insertion direction. For example, in FIG. 17A, tabs 1764, 1766, and 1768 alternate between a first position of tab 1766, which is closer to the first edge 1782 than to the second edge 1784, and a second position of tabs 1764 and 1768, which is closer to the second edge 1784 than to the first edge 1782.

In some embodiments, tab 1770 may be aligned with tab 1768 in the insertion direction, such as shown in FIG. 17A. For example, aligning tab 1770 with tab 1768 in the insertion direction may increase the extent the distal segment 1760 rotates prior to contacting tab 1770 as compared to having tab 1770 offset from tab 1768 (e.g., in FIG. 16). In the illustrated example of FIG. 17A, tab 1770 is shown in the second position and thus does not alternate with tabs 1762, 1764, 1766, and 1768.

It should be appreciated that some embodiments may implement fingers along the same edge of the contact tail that are angled in different directions with respect to the insertion direction and/or fingers along opposite edges of the contact tail that are angled in the same direction with respect to the insertion direction without including multiple tabs, and/or without including any tabs in the compliant portion, as embodiments described herein are not so limited.

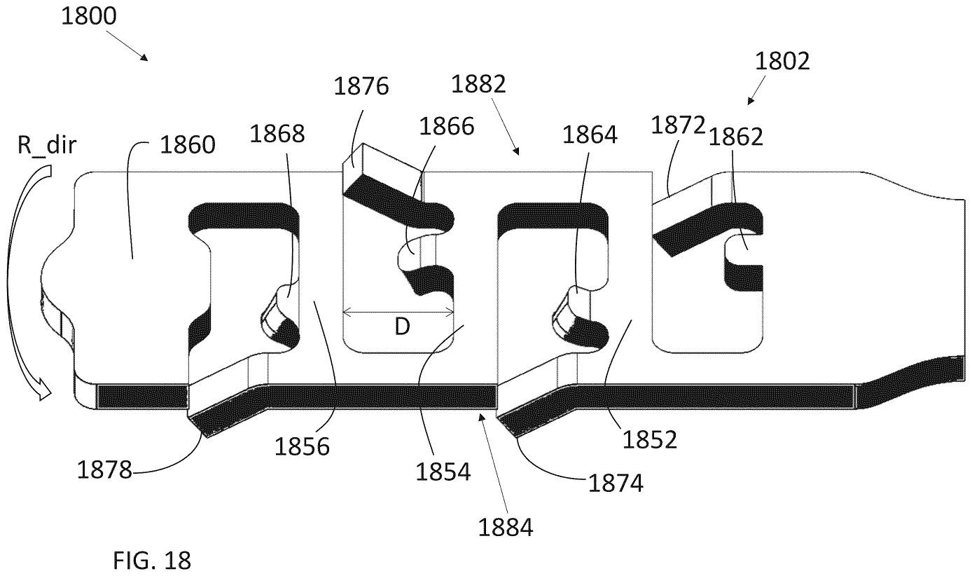

FIG. 18 is a perspective view of an alternative embodiment of the contact tail of FIG. 17A having fewer rungs and longer tabs in the compliant portion, according to some embodiments.

In some embodiments, the contact tail 1800 of FIG. 18 may be configured as described herein for the contact tail 1700 of FIG. 17A. For example, as shown in FIG. 18, the contact tail 1800 includes fingers 1872, 1874, 1876, and 1878 and tabs 1862, 1864, 1866, and 1868. For instance, the contact tail 1800 has a tab 1868 that protrudes from segment 1856 toward the distal segment 1860 of the contact tail, and the distal segment 1860 has an edge projected towards segment 1856 along the insertion direction. Moreover, as described herein for the contact tails of FIGS. 12A-14B and 16-17A, fingers 1874, 1876, and 1878 may be configured to translate compression of segments 1854, 1856, and 1860 along the insertion direction into rotational motion about an axis that is parallel to the insertion direction, and/or to translate compression of segments 1852, 1854, 1856, and 1860 into a spring force along the insertion direction.

In the example of FIG. 18, the compliant portion 1802 of the contact tail 1800 has four segments 1852, 1854, 1856, and 1860 rather than the five segments shown in the example of FIG. 17A. In some embodiments, the contact tail 1800 of FIG. 18 may have the same length as the contact tail 1700 of FIG. 17A, such as by increasing the distance D between segments of the contact tail 1700. For example, the distance between segments of the contact tail 1700 of FIG. 17A may be 0.18 mm whereas the distance D between segments of the contact tail 1800 of FIG. 18 may be 0.25 mm. The inventors have recognized that including fewer segments in the contact tail with greater spacing between the segments may increase the extent to which each segment compresses before contacting the next segment and may decrease the number of points of contact to be established during compression of the segments.

In some embodiments, segments of the contact tail 1800 of FIG. 18 may be configured to rotate less per unit length than the contact tail 1700 of FIG. 17A, though the rotation may be distributed over fewer segments such that some or all segments are rotated the same amount in the contact tail 1800 of FIG. 18 as in the contact tail 1700 of FIG. 17A. For example, segments of the contact tail 1800 of FIG. 18 may be configured to ride the same distance along the fingers as for the contact tail 1700 of FIG. 17A, with the fewer segments of the contact tail 1800 of FIG. 18 as compared to FIG. 17A resulting in less total rotation of the contact tail 1800 over the same length and/or less rotation per unit length for some or all segments. For instance, the fingers 1874, 1876, and 1878 of the contact tail 1800 of FIG. 18 may have the same lengths as the fingers 1774, 1776, and 1778 of the contact tail 1700 of FIG. 17A and tabs 1864 and 1866 of the contact tail 1800 in FIG. 18 may protrude farther from respective segments 1852 and 1854 than corresponding tabs 1764 and 1766 in FIG. 17A so as to contact segments 1854 and 1856, respectively, at or near the end of riding along the fingers despite the different spacing between segments 1854 and 1856 compared to segments 1754 and 1756. As one example, tabs of the contact tails of FIGS. 16 and 17A may be between 0.05 mm and 0.1 mm, such as between 0.07 mm and 0.09 mm, whereas tabs of the contact tail 1800 of FIG. 18 may be between 0.12 mm and 0.17 mm, such as between 0.14 mm and 0.16 mm. In the same or another example, fingers of the contact tails of FIGS. 16, 17A, and 18 may be between 0.18 mm and 0.24 mm, such as between 0.20 mm and 0.21 mm.

In some embodiments, the distal segment 1860 of the contact tail 1800 of FIG. 18 may be configured to rotate farther than the distal segment 1760 of the contact tail 1700 of FIG. 17A, such as due to the increased distance D between segments 1860 and 1856 and, in some cases, tab 1868 having the same length as the tab 1770.

In some embodiments, some fingers of the contact tail may be configured to translate compression of the segments into rotation about an axis parallel to the insertion axis, and some fingers of the contact tail may be configured to contact the segments that have rotated, such as described herein for the contact tail 1700 of FIG. 17A. For example, as shown in FIG. 18, finger 1874 may be configured to translate compression of segments 1852 and 1854 into rotation of segment 1852 in the first rotational direction R_dir, and finger 1872 may be configured to contact segment 1852 when segment 1852 rotates in the first rotational direction R_dir.

In some embodiments, the contact tail may have fingers along the same edge that are angled in different respective directions with respect to the insertion direction and/or fingers along opposite edges of the contact tail that are angled in the same direction with respect to the insertion direction, such as described herein for the contact tail of FIG. 17A. For example, as shown in FIG. 18, finger 1872 and finger 1876 extend along a first edge 1882 of the contact tail 1800, with finger 1872 angled in a first direction with respect to the insertion direction and finger 1874 angled in a second direction with respect to the insertion direction that is opposite to the first direction. As further shown in the configuration of FIG. 18, fingers of the contact tail 1800 that extend along the first and second opposite edges may be angled in a same direction with respect to the insertion direction. For example, in the contact tail 1800 of FIG. 18, finger 1878 extends along a second edge 1884 of the contact tail opposite the first edge 1882 and is angled in the first direction with respect to the insertion direction, like finger 1872. Further shown in FIG. 18 and similar to FIG. 17A, finger 1878 extends along the second edge 1884 and is angled in the first direction with respect to the insertion direction. In the illustrated example, the tab 1868 protrudes from segment 1856 in the second direction, which is different from the first direction in which finger 1878 protrudes from the segment 1856.

In some embodiments, the contact tail may have a tab that protrudes from a respective segment in the insertion direction, such as described herein for the contact tail of FIG. 17A. For example, as shown in FIG. 18, the contact tail 1800 has a tab 1862, farthest from the distal segment 1860, that protrudes in the insertion direction. Similar to the contact tail 1700 of FIG. 17A, having the tab 1862 protrude in the insertion direction makes it less likely to contact the insulative member that holds the contact tail 1800 and cause undesired interference.

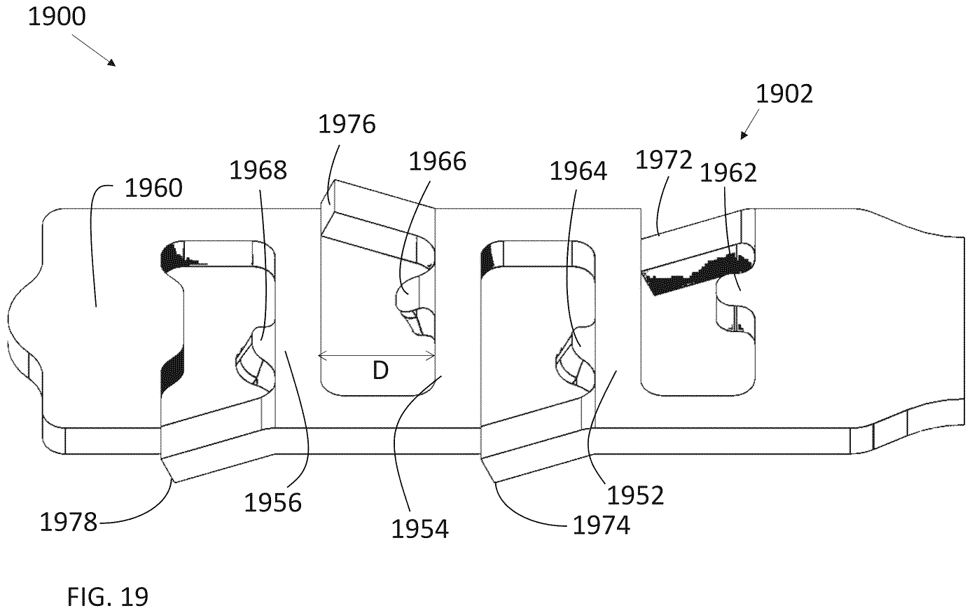

FIG. 19 is a perspective view of a further alternative embodiment of the contact tail of FIG. 17A having fewer rungs and longer fingers in the compliant portion, according to some embodiments.

In some embodiments, the contact tail 1900 of FIG. 19 may be configured as described herein for the contact tail 1800 of FIG. 18. For example, as shown in FIG. 19, the contact tail 1900 includes a compliant portion 1902 having fingers 1972, 1974, 1976, and 1978 and tabs 1962, 1964, 1966, and 1968 protruding toward adjacent segments 1952, 1954, 1956, and 1960 of the contact tail. Moreover, as described herein for the contact tail 1800 of FIG. 18, the fingers 1972, 1974, 1976, and 1978 may be configured to translate compression of the segments along the insertion direction into rotational motion about an axis that is parallel to the insertion direction, and/or into a spring force along the insertion direction. In some embodiments, some fingers of the contact tail 1900 may be configured to translate compression of the segments into rotation about an axis parallel to the insertion axis, and some fingers of the contact tail may be configured to contact the segments that have rotated, such as described herein for the contact tail 1800 of FIG. 18. In some embodiments, the contact tail 1900 may have fingers along the same edge that are angled in different respective directions with respect to the insertion direction and/or fingers along opposite edges of the contact tail 1900 that are angled in the same direction with respect to the insertion direction, such as described herein for the contact tail 1800 of FIG. 18.

In some embodiments, segments of the contact tail 1900 of FIG. 19 may be configured to rotate the same amount per unit length as the contact tail 1700 of FIG. 17A, though the rotation may be distributed over fewer segments such that some or all segments are rotated farther in the contact tail 1900 of FIG. 19 than in the contact tail 1700 of FIG. 17A. For example, segments of the contact tail 1900 of FIG. 19 may ride a longer distance along the fingers than for the contact tail 1700 of FIG. 17A, and the tabs of the contact tail 1900 in FIG. 19 may be configured to contact the segments at or near the end of riding along the fingers despite the different spacing between segments. For instance, the fingers of the contact tail 1900 of FIG. 19 may be longer than corresponding fingers of the contact tail 1700 of FIG. 17A and tabs of the contact tail 1900 of FIG. 19 may have the same lengths as corresponding tabs of the contact tail 1700 of FIG. 17A.

In some embodiments, the contact tail 1900 of FIG. 19 may have the same number of segments and distance D between segments as the contact tail 1800 of FIG. 18, except the tabs of the contact tail 1900 of FIG. 19 may be shorter than the corresponding tabs of the contact tail 1800 of FIG. 18 and the fingers of the contact tail 1900 of FIG. 19 may be longer than the corresponding fingers of the contact tail 1900 of FIG. 19. For example, the tabs of the contact tail 1800 of FIG. 18 may be the same length as corresponding tabs of the contact tail 1600 of FIG. 16. As one example, fingers of the contact tails of FIGS. 16, 17A, and 18 may be between 0.18 mm and 0.24 mm, such as between 0.20 mm and 0.21 mm, whereas fingers of the contact tail 1900 of FIG. 19 may be between 0.27 mm and 0.31 mm, such as between 0.28 mm and 0.29 mm. In the same or another example, tabs of the contact tails of FIGS. 16, 17A, and 19 may be between 0.05 mm and 0.1 mm, such as between 0.07 mm and 0.09 mm. In some embodiments, the distal segment of the contact tail 1900 of FIG. 19 may be configured to rotate the same amount as the distal segment of the contact tail 1800 of FIG. 18.

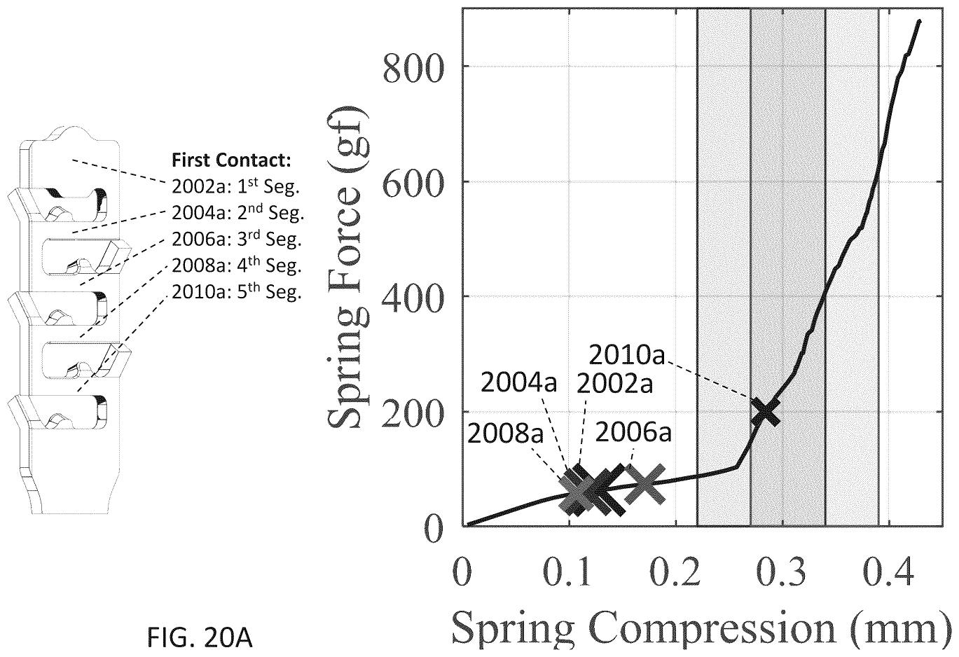

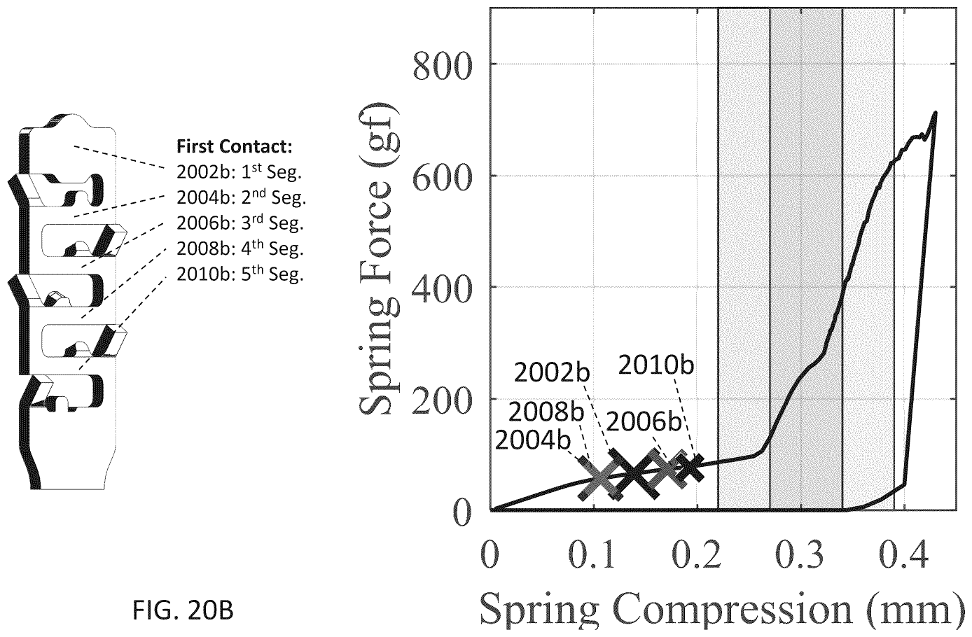

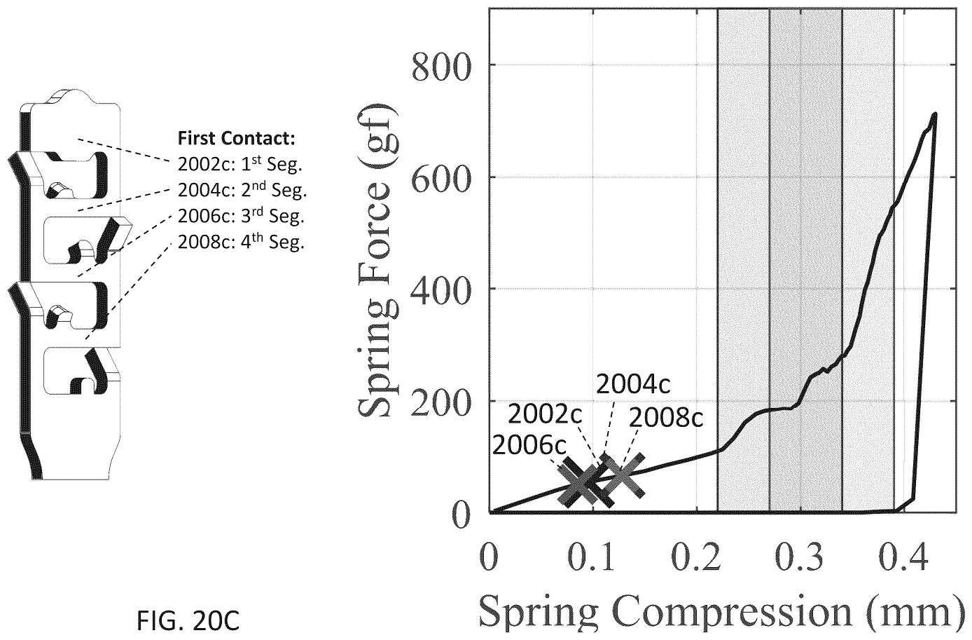

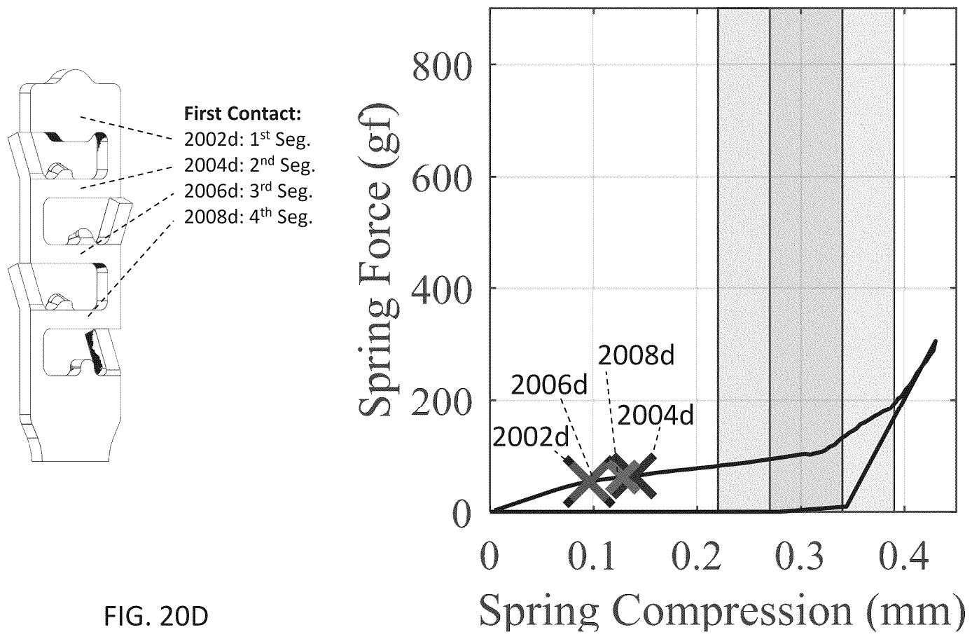

FIG. 20A is a graph of spring force vs. spring compression for the contact tail of FIG. 16. FIG. 20B is a graph of spring force vs. spring compression for the contact tail of FIG. 17A. FIG. 20C is a graph of spring force vs. spring compression for the contact tail of FIG. 18. FIG. 20D is a graph of spring force vs. spring compression for the contact tail of FIG. 19.

In the graphs of FIGS. 20A-20D, spring force generated by the contact tails is plotted against compression of the contact tails, and markers on the graph indicate at which point along the spring compression axis (which is parallel to the insertion direction) each segment of the contact tail contacts the next pat of the contact tail (e.g., next segment or base), which may occur, for example, at the finger that is angled from the next part of the contact tail. In FIG. 20A, markers 2002a, 2004a, 2006a, 2008a, and 2010a indicate compression at first contact for first through fifth segments of the contact tail 1600 of FIG. 16. In FIG. 20B, markers 2002b, 2004b, 2006b, 2008b, and 2010b indicate compression at first contact for segments 1760, 1758, 1756, 1754, and 1752, respectively, of the contact tail 1700 of FIG. 17A. In FIG. 20C, markers 2002c, 2004c, 2006c, and 2008c indicate compression at first contact for segments 1860, 1856, 1854, and 1852, respectively, of the contact tail 1800 of FIG. 18. In FIG. 20D, markers 2002d, 2004d, 2006d, and 2008d indicate compression at first contact for segments 1960, 1956, 1954, and 1952, respectively, of the contact tail 1900 of FIG. 19.

As shown in FIG. 20A for the contact tail 1600 of FIG. 16, the fifth segment may not contact the finger angled from the base of the contact tail until the contact tail 1600 has been compressed by almost 0.3 mm. This may be caused, in some cases, by the fifth segment being pulled away from the base of the contact tail by rotation of the fourth segment. In contrast, as shown in FIG. 20B for the contact tail 1700 of FIG. 17A, segment 1752 may contact finger 1772 angled from the base 1750 after less than 0.2 mm of spring compression. This may be caused, in some cases, by the angle of finger 1772. In some embodiments, the contact tail 1700 of FIG. 17A may exhibit improved electrical contact between segments when compressed to a lesser extent than may be needed to achieve similar electrical contact using a different contact tail. FIGS. 20C-20D show that segments 1852 and 1952 of the contact tails of FIGS. 18-19, respectively, exhibit similar behavior to segment 1752 of the contact tail of FIG. 17A, for instance, due to the similarity between fingers 1872 and 1972 of the contact tails of FIGS. 18-19 and finger 1772 of the contact tail 1700 of FIG. 17A.

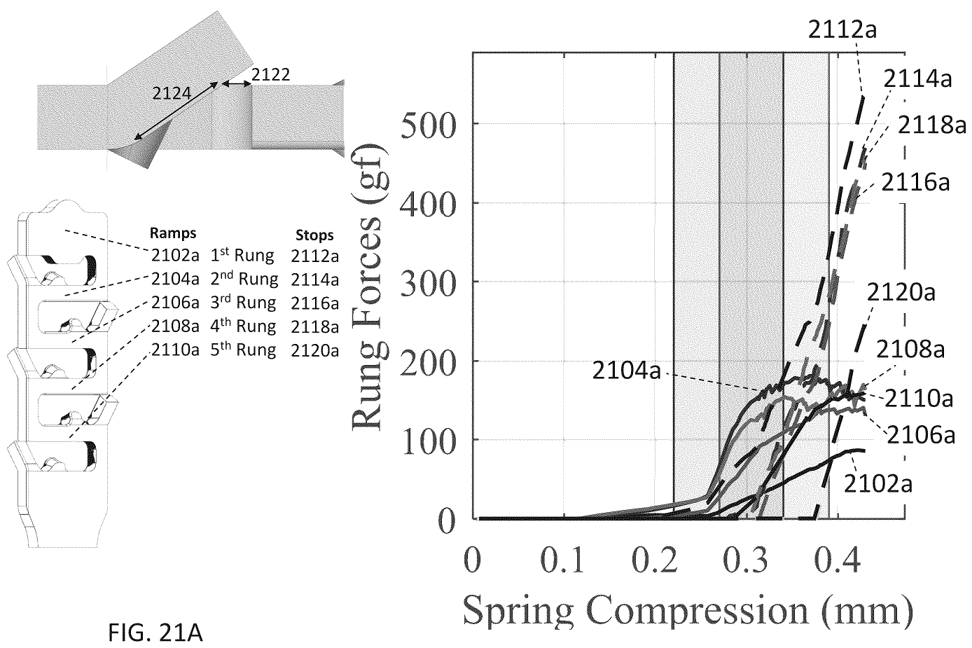

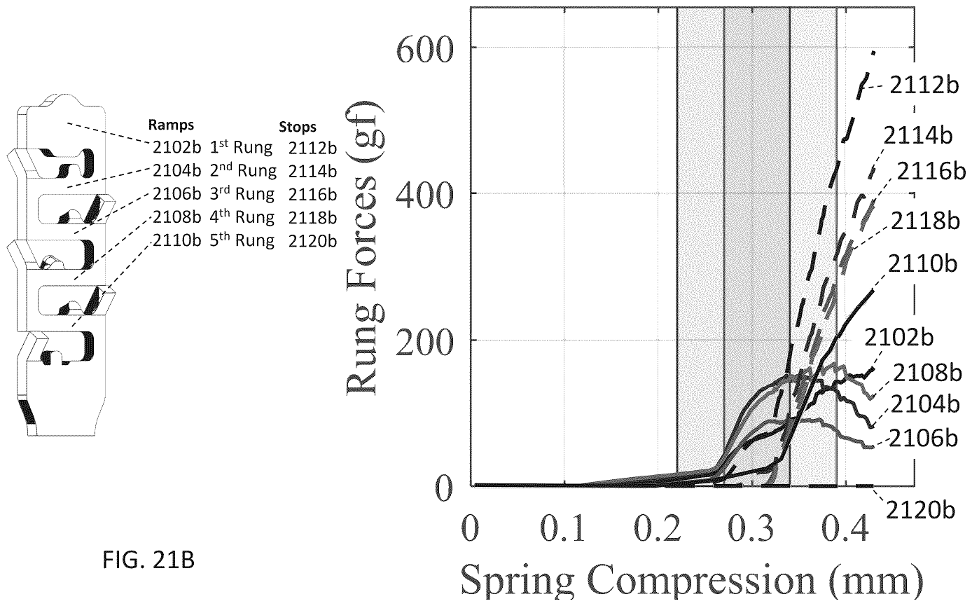

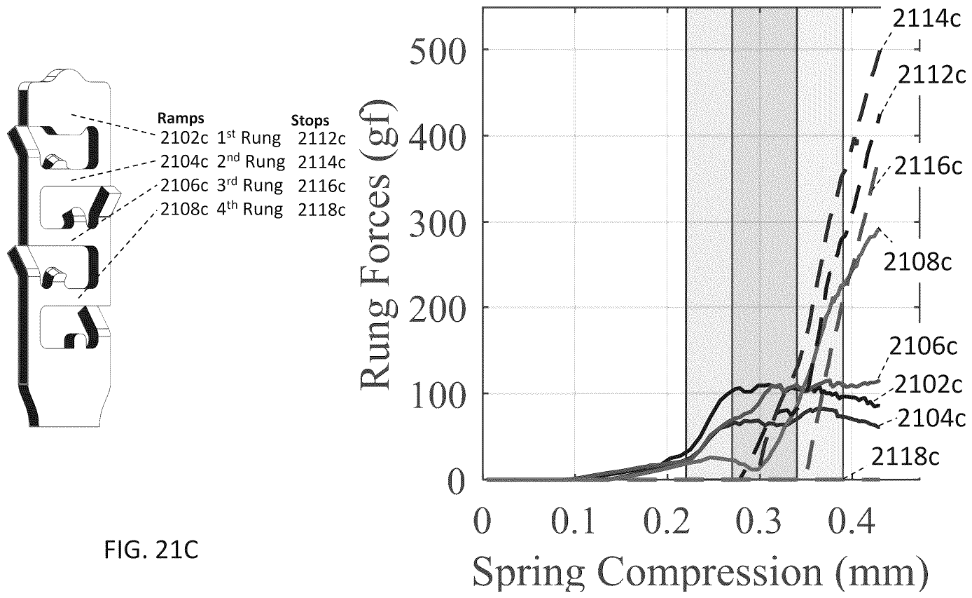

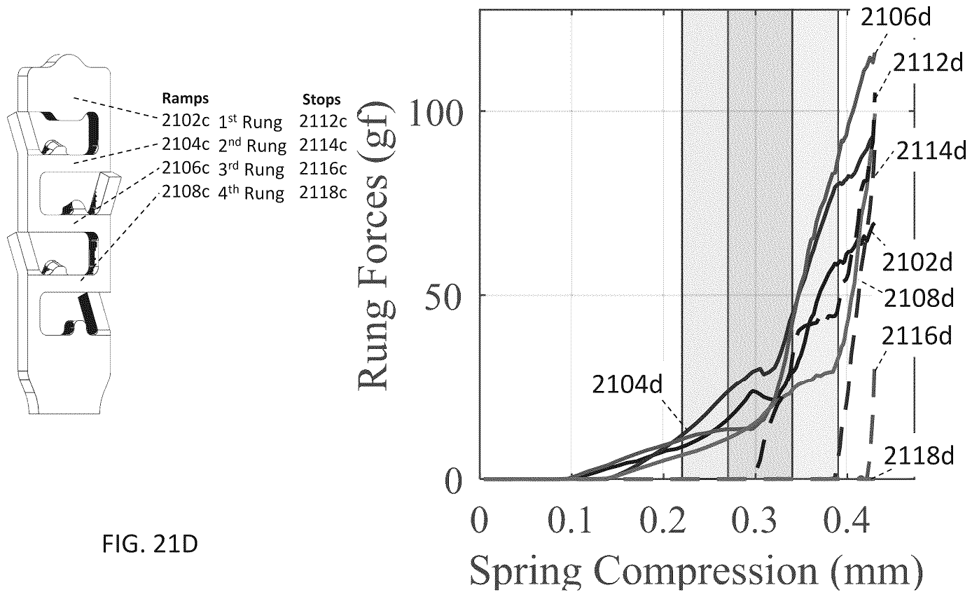

FIG. 21A is a graph of rung force vs. spring compression for the contact tail of FIG. 16. FIG. 21B is a graph of rung force vs. spring compression for the contact tail of FIG. 17A. FIG. 21C is a graph of rung force vs. spring compression for the contact tail of FIG. 18. FIG. 21D is a graph of rung force vs. spring compression for the contact tail of FIG. 19.

In the graphs of FIGS. 21A-21D, force exerted by each segment of the contact tails on the fingers (“ramps”) and the tabs (“stops”) is plotted against compression of the contact tails. In FIG. 21A, traces 2102a, 2104a, 2106a, 2108a, and 2110a indicate force exerted by first through fifth segments of the contact tail 1600 of FIG. 16 against respective fingers of the contact tail, and traces 2112a, 2114a, 2116a, 2118a, and 2120a indicate force exerted by the first through fifth segments of the contact tail 1600 of FIG. 16 against respective tabs of the contact tail. In FIG. 21B, traces 2102b, 2104b, 2106b, 2108b, and 2110b indicate force exerted by segments 1760, 1758, 1756, 1754, and 1752, against fingers 1780, 1778, 1776, 1774, and 1772, respectively, of the contact tail 1700 of FIG. 17A, and traces 2112b, 2114b, 2116b, 2118b, and 2120b indicate force exerted by segments 1760, 1758, 1756, 1754, and 1752, against tabs 1770, 1768, 1766, 1764, and 1762, respectively, of the contact tail 1700. In FIG. 21C, traces 2102c, 2104c, 2106c, and 2108c, indicate force exerted by segments 1860, 1856, 1854, and 1852, against fingers 1878, 1876, 1874, and 1872, respectively, of the contact tail 1800 of FIG. 18, and traces 2112c, 2114c, 2116c, and 2118c indicate force exerted by segments 1860, 1856, 1854, and 1852, against tabs 1868, 1866, 1864, and 1862, respectively, of the contact tail 1800. In FIG. 21D, traces 2102d, 2104d, 2106d, and 2108d, indicate force exerted by segments 1960, 1956, 1954, and 1952, against fingers 1978, 1976, 1974, and 1972, respectively, of the contact tail 1900 of FIG. 19, and traces 2112d, 2114d, 2116d, and 2118d indicate force exerted by segments 1960, 1956, 1954, and 1952, against tabs 1968, 1966, 1964, and 1962, respectively, of the contact tail 1900.

In some embodiments, when a segment is compressed, the segment may first move toward a respective finger (see 2122 in FIG. 21A), and then the finger may contact and exert force on the finger while riding along the finger (see 2124 in FIG. 21A) until the segment may contact and exert force on a respective tab. For instance, as shown in FIGS. 21A-21D, each segment exerts force on a respective finger starting when the segment first contacts the finger (as marked in FIGS. 20A-20D), which force increases slightly as the segment rides along the finger, and then the segment exerts a significantly increasing force on the tab and a decreasing force on the finger starting when the segment first contacts the tab.

As shown in FIG. 21A for the contact tail 1600 of FIG. 16, similar to FIG. 20A, the fifth segment may not begin exerting any force on the finger until the contact tail has been compressed by almost 0.3 mm and the segment first contacts the finger. In contrast, as shown in FIG. 20B for the contact tail 1700 of FIG. 17A, similar to FIG. 20B, segment 1752 may begin exerting force on finger 1772 after less than 0.2 mm of spring compression. FIGS. 21C-21D show that segments 1852 and 1952 of the contact tails of FIGS. 18-19, respectively, exhibit similar behavior to segment 1752 of the contact tail 1700 of FIG. 17A. As shown in FIGS. 21B-21D, segments 1752, 1852, and 1952 begin exerting force on tabs 1762, 1862, and 1962, respectively, after less compression of the contact tail than in FIG. 21A.

Alternatively or additionally, structures holding contact tails in a connector housing may facilitate a controlled rotation of the contact tails and/or generation of a more repeatable contact force, which may lead to less variation in performance of a connector as described herein. An example of such a structure is shown in FIGS. 15A-15B.

Referring to FIGS. 15A-15B, a portion 1512 of a signal unit is shown with a hub 1516 inserted through a slot in a signal conductor of the signal unit proximate the contact tail 1508, in accordance with some embodiments. The inventors have recognized that holding the signal conductor in place with the insulative member may increase the insertion force applied to the contact tail when compressed against a surface of a substrate. Alternatively or additionally, holding the signal conductor in place with the insulative member may bias the signal conductor into a predetermined position such that the relative position of the signal conductor is more finely controlled, thereby providing finer control over the resulting contact force.

In some embodiments, an electrical connector such as described above may include a housing having a hub press fit within a slot of an intermediate portion of a conductive element held within the housing. For example, in FIG. 15A, a hub 1516 of an insulative member 1510 is inserted into a slot in an intermediate portion 1506 of a conductive element proximate the contact tail 1508. In the illustrated embodiment, the hub 1516 has a tapered portion 1518 configured to hold the conductive element on the hub after press fit insertion. For instance, the tapered portion 1518 may be configured to hold the conductive element on the hub 1516 in a predetermined position, which may facilitate more repeatable positioning and contact force from the contact tails 1508 when compliant portion 1502 is compressed. Alternatively or additionally, the tapered portion 1518 may be configured to hold the conductive element on the hub 1516 when the temperature of the insulative member 1510 increases and the hub 1516 expands during operation. In some embodiments, the tapered portion 1518 may have a tilt of 5-15 degrees, such as 10 degrees. While the hub 1516 is shown for a single conductive element of a connector, it should be appreciated that some or all insulative members holding conductive elements may have hubs press fit within respective slots of the conductive elements.

Additional embodiments of technology described herein are described further below.

In a first example, an electrical connector, comprises a pair of signal conductors having contact tails adapted for connection to a surface of a substrate in an insertion direction, wherein each of the contact tails comprises a plurality of segments spaced from one another in the insertion direction and comprising a first segment spaced from another of the plurality of segments in the insertion direction and comprising a rounded tip protruding in the insertion direction and configured to apply pressure to the surface of the substrate and wings alongside the rounded tip and configured to tune an impedance of the contact tail, wherein the plurality of segments are configured to compress along the insertion direction when the rounded tip is pressed against the surface of the substrate in the insertion direction.

Optionally, the wings are directly adjacent the rounded tip.

Optionally, the wings have a larger radius of curvature than the rounded tip.

Optionally, the wings are configured to provide capacitance for the contact tail to tune the impedance.

Optionally, the contact tail has broad sides and edges that are narrower than the broad sides, the wings are at the edges of the contact tail, and the rounded tip is between the wings along the broad sides.

Optionally, the plurality of segments are configured to generate a spring force along the insertion direction when compressed.

Optionally, the plurality of segments are configured to rotate about an axis parallel to the insertion direction when compressed.

Optionally, the electrical connector further comprises an insulative member supporting the pair of signal conductors and comprising projections configured to control rotation of the contact tails about the axis.

Optionally, the electrical connector further comprises electromagnetic shielding for the pair of signal conductors extending alongside the contact tails.

Optionally, the electromagnetic shielding comprises press fit tails on opposite sides of the contact tails.

Optionally, the electromagnetic shielding bounds the contact tails along a perimeter extending 360 degrees around the contact tails.

Optionally, the first segment is at a distal end of the plurality of segments in the insertion direction.

In a second example, an electrical connector comprises a mounting face, the electrical connector comprising a housing and a plurality of conductive elements held within the housing, each of the plurality of conductive elements comprising a mating contact portion, a contact tail extending from the housing at the mounting face, a compliant portion coupled to the contact tail and movable with respect to the housing in a first direction perpendicular to the mounting face, and an intermediate portion, held within the housing, coupling the mating contact portion to the compliant portion, wherein the contact tail comprises, at the mounting face, an edge comprising a rounded tip having a first radius of curvature and a portion directly adjacent the rounded tip having a second radius of curvature larger than the first radius of curvature.

Optionally, the edge further comprises a second portion directly adjacent the rounded tip having a third radius of curvature larger than the first radius of curvature, and wherein the rounded tip protrudes from between the portion of the edge and the second portion of the edge.

Optionally, the compliant portion is compressible in the first direction to generate a spring force along the first direction.

Optionally, the compliant portion is configured to rotate about an axis parallel to the first direction when compressed.

Optionally, the electrical connector further comprises an insulative member supporting the contact tails and comprising projections configured to control rotation of the compliant portions about the axis.

Optionally, the electrical connector further comprises electromagnetic shielding for each of a plurality of pairs of the plurality of conductive elements, the electromagnetic shielding extending alongside the contact tails.

Optionally, the electromagnetic shielding comprises press fit tails on opposite sides of the contact tails of pairs of the plurality of pairs.

Optionally, the electromagnetic shielding bounds the contact tails of the pairs of the plurality of pairs along a perimeter extending 360 degrees around the contact tails.

In a third example, an electrical connector, comprises a pair of signal conductors having contact tails adapted for connection to a surface of a substrate in an insertion direction, wherein each of the contact tails comprises a plurality of segments spaced from one another in the insertion direction and comprising a first segment spaced from another of the plurality of segments in the insertion direction and comprising a rounded tip having a radius between 0.1 mm and 0.2 mm, wherein the plurality of segments are configured to compress along the insertion direction when the rounded tip is pressed against the surface of the substrate in the insertion direction.

Optionally, the rounded tip has a radius between 0.125 mm and 0.175 mm.

Optionally, the rounded tip has a radius between 0.14 mm and 0.16 mm.

Optionally, the rounded tip has a radius of 0.15 mm.

Optionally, the plurality of segments are configured to generate a spring force along the insertion direction when compressed.

Optionally, the plurality of segments are configured to rotate about an axis parallel to the insertion direction when compressed.

Optionally, the electrical connector further comprises an insulative member supporting the pair of signal conductors and comprising projections configured to control rotation of the contact tails about the axis.

Optionally, the electrical connector further comprises electromagnetic shielding for the pair of signal conductors extending alongside the contact tails.

Optionally, the electromagnetic shielding comprises press fit tails on opposite sides of the contact tails.

Optionally, the electromagnetic shielding bounds the contact tails along a perimeter extending 360 degrees around the contact tails.

Optionally, the first segment is at a distal end of the plurality of segments in the insertion direction.

In a fourth example, an electrical connector comprises a mounting face, the electrical connector comprising a housing and a plurality of conductive elements held within the housing, each of the plurality of conductive elements comprising a mating contact portion, a contact tail extending from the housing at the mounting face, a compliant portion coupled to the contact tail and movable with respect to the housing in a first direction perpendicular to the mounting face, and an intermediate portion, held within the housing, coupling the mating contact portion to the compliant portion, wherein the contact tail comprises, at the mounting face, a rounded tip having a radius between 0.1 mm and 0.2 mm protruding in the first direction.

Optionally, the rounded tip has a radius between 0.125 mm and 0.175 mm.

Optionally, the rounded tip has a radius between 0.14 mm and 0.16 mm.

Optionally, the rounded tip has a radius of 0.15 mm.

Optionally, the compliant portion is compressible in the first direction to generate a spring force along the first direction.

Optionally, the compliant portion is configured to rotate about an axis parallel to the first direction when compressed.

Optionally, the electrical connector further comprises an insulative member supporting the contact tails and comprising projections configured to control rotation of the compliant portions about the axis.

Optionally, the electrical connector further comprises electromagnetic shielding for each of a plurality of pairs of the plurality of conductive elements, the electromagnetic shielding extending alongside the contact tails.

Optionally, the electromagnetic shielding comprises press fit tails on opposite sides of the contact tails of pairs of the plurality of pairs.

Optionally, the electromagnetic shielding bounds the contact tails of the pairs of the plurality of pairs along a perimeter extending 360 degrees around the contact tails.

In a fifth example, an electrical connector, comprises a pair of signal conductors having contact tails adapted for connection to a surface of a substrate in an insertion direction, wherein each of the contact tails comprises a plurality of segments spaced from one another in the insertion direction, a first segment of the plurality of segments comprising a first tab protruding towards a second segment of the plurality of segments, wherein the plurality of segments are configured to compress along the insertion direction when the contact tail is pressed against the surface of the substrate in the insertion direction the plurality of segments are configured to rotate about an axis parallel to the insertion direction when compressed and the first tab is configured to limit movement of the first segment and the second segment toward one another when the plurality of segments are compressed.

Optionally, the first tab protrudes from the first segment towards the second segment in the insertion direction.

Optionally, the first tab protrudes from the first segment towards the second segment in a first direction and the second segment comprises an edge projected towards the first segment along the insertion direction.

Optionally, the first direction is acute with respect to the insertion direction.

Optionally, the first direction is parallel to the insertion direction.

Optionally, the first tab is rigidly connected to the first segment.

Optionally, the first tab is configured to limit rotation of the first segment and the second segment relative to one another when compressed.

Optionally, the plurality of segments are configured to generate a spring force along the insertion direction when compressed.

Optionally, the plurality of segments comprise fingers between adjacent segments of the plurality of segments.

Optionally, the fingers are configured to translate compression along the insertion direction into rotational motion about the axis.

Optionally, the fingers are angled with respect to the insertion direction.

Optionally, the first segment comprises a first finger of the fingers, and the first finger and the first tab protrude from the first segment in different directions.

Optionally, the different directions are transverse to the insertion direction.

Optionally, the fingers are configured to translate compression of the plurality of segments along the insertion direction into a spring force along the insertion direction.

Optionally, the first segment further comprises a finger of the fingers configured to translate compression of the first segment against the second segment into rotation of the first segment with respect to the second segment.

Optionally, each segment of the plurality of segments is elongated in a direction perpendicular to the insertion direction, and wherein compressing the plurality of segments moves the segments closer to one another along the insertion direction.

Optionally, rungs of the plurality of segments are configured to ride along fingers between adjacent segments of the plurality of segments to rotate about the axis when compressed.

Optionally, the second segment is at a distal end of the plurality of segments in the insertion direction, and the first segment is adjacent the second segment in the insertion direction.

Optionally, the plurality of segments further comprises a third segment, the first segment is spaced from the third segment in the insertion direction, the third segment comprises a second tab protruding towards the first segment, and the second tab is configured to limit movement of the third segment and the first segment relative to one another when compressed.

Optionally, the first tab and the second tab are offset from one another in a first direction perpendicular to the insertion direction.

Optionally, the first tab and the second tab are aligned in the insertion direction.

Optionally, the plurality of segments comprise a plurality of tabs that includes the second tab, and the plurality of tabs alternate along the insertion direction between a first position along the first direction and a second position along the first direction.

Optionally, the plurality of tabs further includes the first tab.

Optionally, the plurality of segments comprise fingers between adjacent segments of the plurality of segments, and each of the plurality of tabs is positioned, in the first direction, between a respective pair of the fingers.

Optionally, the second tab and a third tab of the plurality of tabs protrude from respective segments of the plurality of segments in a same direction, transverse to the insertion direction, as a first of the respective pair of the fingers and protrudes in an opposite direction, transverse to the insertion direction, as a second of the respective pair of the fingers.

Optionally, the first tab protrudes from the first segment in a same direction, transverse to the insertion direction, as the first of the respective pair of the fingers and protrudes in the opposite direction, transverse to the insertion direction, as the second of the respective pair of the fingers.

Optionally, the electrical connector further comprises an insulative member supporting the pair of signal conductors and comprising projections configured to control rotation of the contact tails about the axis.

Optionally, the first tab protrudes from the first segment towards the second segment in the insertion direction.

Optionally, the second segment is at a distal end of the plurality of segments in the insertion direction, the first segment is adjacent the second segment in the insertion direction, and a third tab protrudes in the insertion direction toward a farthest segment of the plurality of segments from the second segment in the insertion direction.

Optionally, the third tab is recessed into the contact tail.

Optionally, the electrical connector further comprises electromagnetic shielding for the pair of signal conductors extending alongside the contact tails.

Optionally, the electromagnetic shielding comprises press fit tails on opposite sides of the contact tails.

Optionally, the electromagnetic shielding bounds the contact tails along a perimeter extending 360 degrees around the contact tails.

In a sixth example, an electrical connector, comprises a pair of signal conductors having contact tails adapted for connection to a surface of a substrate in an insertion direction, wherein each of the contact tails comprises a plurality of segments spaced from one another in the insertion direction, wherein the plurality of segments are configured to compress against one another along the insertion direction when the contact tail is pressed against the surface of the substrate in the insertion direction, the plurality of segments are configured to rotate about an axis parallel to the insertion direction when compressed, and a first segment of the plurality of segments is configured to limit rotation of a second segment of the plurality of segments with respect to the first segment to 4 degrees or less when the first segment and a third segment of the plurality of segments are compressed towards one another along the insertion direction.

Optionally, the first segment is configured to limit rotation of the second segment about the axis with respect to the first segment beyond 3.5 degrees when the first segment and the third segment are compressed toward one another along the insertion direction.

Optionally, the first segment is configured to limit rotation of the second segment about the axis with respect to the first segment beyond 2.5 degrees when the first segment and the third segment are compressed toward one another along the insertion direction.

Optionally, the plurality of segments are configured to rotate at least 20 degrees about the axis when compressed along the insertion direction.

Optionally, the plurality of segments are configured to rotate at least at least 20 degrees from a first end segment of the plurality of segments along the insertion direction to a second end segment of the plurality of segments along the insertion direction when compressed along the insertion direction.

Optionally, the plurality of segments are configured to rotate about the axis at least 6 degrees per mm of length of the plurality of segments in the insertion direction.

Optionally, the plurality of segments comprises a subset of segments connected between a first end segment of the plurality of segments along the insertion direction and a second end segment of the plurality of segments along the insertion direction, and each segment of the subset of segments is configured to limit rotation of the segment with respect to another segment of the plurality of segments beyond 3.5 degrees when the segment and the another segment are compressed toward one another along the insertion direction.

Optionally, each segment of the subset of segments is configured to limit rotation of the segment with respect to the another segment of the plurality of segments beyond 3 degrees when the segment and the another segment are compressed toward one another along the insertion direction.

Optionally, the subset of segments comprises each segment of the plurality of segments that is not configured to contact the surface of the substrate.

Optionally, the plurality of segments comprises a segment configured to rotate at least 2 degrees with respect to another segment of the plurality of segments when the plurality of segments are compressed along the insertion direction.

Optionally, the first segment comprises a tab protruding toward the third segment and configured to limit rotation of the first segment with respect to the second segment about the axis.

Optionally, the plurality of segments comprise fingers between adjacent segments of the plurality of segments, and the tab is positioned, in a first direction perpendicular to the insertion direction, between a respective pair of the fingers.

Optionally, the fingers are configured to translate compression along the insertion direction into rotational motion about the axis.

Optionally, the fingers are angled with respect to the insertion direction.

Optionally, the plurality of segments comprise fingers between pairs of adjacent segments of the plurality of segments and a plurality of tabs positioned, in a first direction perpendicular to the insertion direction, between a respective pair of the fingers, each of the plurality of tabs is configured to limit rotation of a first of a respective pair of adjacent segments with respect to a second of the respective pair of adjacent segments, and tabs of the plurality of tabs alternate along the insertion direction between a first position along the first direction and a second position along the first direction.

Optionally, the tabs that alternate along the insertion direction between the first position and the second position comprise the tab.

Optionally, the electrical connector further comprises an insulative member supporting the pair of signal conductors and comprising projections configured to control rotation of the plurality of segments about the axis.

Optionally, the electrical connector further comprises electromagnetic shielding for the pair of signal conductors extending alongside the plurality of segments.

Optionally, the electromagnetic shielding comprises press fit tails on opposite sides of the contact tails.

Optionally, the electromagnetic shielding bounds the plurality of segments along a perimeter extending 360 degrees around the plurality of segments.

In a seventh example, an electrical connector comprises a mounting face, the electrical connector comprising a housing, and a plurality of conductive elements held within the housing, each of the plurality of conductive elements comprising a mating contact portion, a contact tail extending from the housing at the mounting face, a compliant portion coupled to the contact tail and movable with respect to the housing in a first direction perpendicular to the mounting face, and an intermediate portion, held within the housing, coupling the mating contact portion to the compliant portion, the intermediate portion comprising a slot, wherein the housing comprises a hub press fit within the slot.

In an eighth example, an electrical connector, comprises a pair of signal conductors having contact tails adapted for connection to a surface of a substrate in an insertion direction, wherein each of the contact tails comprises a plurality of segments spaced from one another in the insertion direction and comprising a first segment spaced from another of the plurality of segments in the insertion direction and comprising a tip, wherein the plurality of segments are configured to compress along the insertion direction when the tip is pressed against the surface of the substrate in the insertion direction, the plurality of segments comprise copper titanium (Cu—Ti), and the tip comprises plating that is more conductive than Cu—Ti.

Optionally, the tip comprises gold plating.

Optionally, a base metal of the plurality of segments comprises a Cu—Ti alloy.

In a ninth example, an electrical connector comprises a mounting face, the electrical connector comprising a housing and a plurality of conductive elements held within the housing, each of the plurality of conductive elements comprising a mating contact portion, a contact tail extending from the housing at the mounting face and comprising a tip at the mounting face, a compliant portion coupled to the contact tail and movable with respect to the housing in a first direction perpendicular to the mounting face, and an intermediate portion, held within the housing, coupling the mating contact portion to the compliant portion, wherein the compliant portion comprises copper titanium (Cu—Ti) and the tip comprises plating that is more conductive than Cu—Ti.

Optionally, a base metal of the compliant portion comprises a Cu—Ti alloy.

Optionally, the tip comprises gold plating.

In a tenth example, an electrical connector comprises a pair of signal conductors having contact tails adapted for connection to a surface of a substrate in an insertion direction, wherein each of the contact tails comprises a plurality of segments spaced from one another in the insertion direction and configured to compress along the insertion direction when the contact tail is pressed against the surface of the substrate in the insertion direction, wherein the plurality of segments comprise a plurality of fingers that are between adjacent segments of the plurality of segments and extend along first and second opposite edges of the contact tail, and wherein fingers of the plurality of fingers that extend along the first edge of the contact tail are angled in different respective directions with respect to the insertion direction.

Optionally, the plurality of fingers comprise a first finger extending along the first edge of the contact tail and angled in a first direction with respect to the insertion direction, a second finger extending along the first edge of the contact tail and angled in a second direction with respect to the insertion direction that is opposite to the first direction, and a third finger extending along the second edge of the contact tail and angled in the first direction with respect to the insertion direction.

Optionally, the plurality of fingers further comprises a fourth finger extending along the second edge and angled in the first direction with respect to the insertion direction.

Optionally, the first and second edges of the contact tail extend in the insertion direction.

Optionally, the plurality of segments are configured to rotate about an axis parallel to the insertion direction when compressed.

Optionally, the plurality of fingers are configured to translate compression of the plurality of segments along the insertion direction into rotational motion about an axis that is parallel to the insertion direction.

Optionally, rungs of the plurality of segments are configured to ride along the plurality of fingers to rotate about the axis when compressed.

Optionally, the plurality of fingers are configured to translate compression of the plurality of segments along the insertion direction into a spring force along the insertion direction.

Optionally, the plurality of segments further comprise a first tab configured to limit movement of the plurality of segments towards one another when the plurality of segments are compressed.

Optionally, the first tab protrudes from a first segment of the plurality of segments in a direction transverse to the insertion direction.

Optionally, the plurality of segments comprise a plurality of tabs, including the first tab, that are configured to limit movement of the plurality of segments towards one another when the plurality of segments are compressed.

Optionally, the plurality of segments comprises a second tab that protrudes from a second segment of the plurality of segments in a direction opposite to the direction in which the first tab protrudes with respect to the insertion direction.

Optionally, the plurality of tabs alternate along the insertion direction between a first position and a second position that is offset from the first position in a third direction perpendicular to the insertion direction, the first position being closer to the first edge than to the second edge, and the second position being closer to the second edge than to the first edge.

In an eleventh example, an electrical connector comprises a pair of signal conductors having contact tails adapted for connection to a surface of a substrate in an insertion direction, wherein each of the contact tails comprises a compliant portion comprising a plurality of segments spaced from one another in the insertion direction and configured to compress along the insertion direction when the contact tail is pressed against the surface of the substrate in the insertion direction, a first finger between adjacent first and second segments of the plurality of segments and configured to translate compression of the first segment and the second segment into rotation of the first segment in a first rotational direction about an axis that is parallel to the insertion direction, and a second finger configured to contact the first segment when the first segment rotates in the first rotational direction about the axis towards the second finger.

Optionally, the second finger is configured to interfere with rotation of the first segment in the first rotational direction about the axis.

Optionally, the first finger and the second finger are configured to translate compression of the plurality of segments along the insertion direction into a spring force along the insertion direction.

Optionally, the first finger extends along a first edge of the contact tail and the second finger extends along a second edge of the contact tail that is opposite the first edge.

Optionally, the first edge and the second edge extend in the insertion direction.

Optionally, the first finger and the second finger are angled in a same direction with respect to the insertion direction.

Optionally, each of the contact tails comprises a plurality of fingers, including the first finger, that are between adjacent segments of the plurality of segments and configured to translate compression of the plurality of segments into rotation about the axis.

Optionally, the plurality of fingers comprises a third finger that is angled in a direction with respect to the insertion direction that is opposite to a direction with respect to the insertion direction in which the first finger and the second finger are angled.

Optionally, the third finger extends along a same edge of the contact tail as the second finger.

Optionally, the plurality of fingers comprises a fourth finger that extends along a same edge of the contact tail as the first finger and is angled in a same direction with respect to the insertion direction as the first finger.

Optionally, the plurality of segments further comprise a first tab configured to limit movement of the plurality of segments towards one another when the plurality of segments are compressed.

Optionally, the first tab protrudes from the first segment towards the second segment.

Optionally, the first tab and the first finger protrude from the first segment in different directions with respect to the insertion direction.

Optionally, the first tab and the first finger protrude from the first segment in opposite directions with respect to the insertion direction.

Optionally, the plurality of segments comprise a plurality of tabs, including the first tab, that are configured to limit movement of the plurality of segments towards one another when the plurality of segments are compressed.

Optionally, each of the plurality of segments comprises a respective tab of the plurality of tabs.

Optionally, the plurality of tabs alternate along the insertion direction between a first position and a second position that is offset from the first position in a direction that is perpendicular to the insertion direction, the first position being closer to an edge along which the first finger extends than to an edge along which the second finger extends, and the second position being closer to the edge along which the second finger extends than to the edge along which the first finger extends.

Having thus described several aspects of at least one embodiment of this invention, it is to be appreciated that various alterations, modifications, and improvements will readily occur to those skilled in the art.

For example, FIGS. 7A-7B illustrate a configuration in which a separate insulative component for the mating interface of each signal unit is integrated into a wafer subassembly. In other examples, a second component may include insulative portions for multiple signal units of a wafer subassembly.

As another example, a wafer housing is described as formed of a lossy material. In other examples, the housing may be formed of an insulative material.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electrical connector, comprising:
a pair of signal conductors having contact tails adapted for connection to a surface of a substrate in an insertion direction, wherein each of the contact tails comprises:
a plurality of segments spaced from one another in the insertion direction, a first segment of the plurality of segments comprising a first tab protruding towards a second segment of the plurality of segments, wherein:
the plurality of segments are configured to compress along the insertion direction when the contact tail is pressed against the surface of the substrate in the insertion direction;
the plurality of segments are configured to rotate about an axis parallel to the insertion direction when compressed; and
the first tab is configured to limit movement of the first segment and the second segment toward one another when the plurality of segments are compressed.

2. The electrical connector of claim 1, wherein the first tab protrudes from the first segment towards the second segment in the insertion direction.

3. The electrical connector of claim 1, wherein the first tab protrudes from the first segment towards the second segment in a first direction and the second segment comprises an edge projected towards the first segment along the insertion direction.

4. The electrical connector of claim 3, wherein the first direction is acute with respect to the insertion direction.

5. The electrical connector of claim 3, wherein the first direction is parallel to the insertion direction.

6. The electrical connector of claim 1, wherein the first tab is rigidly connected to the first segment.

7. The electrical connector of claim 1, wherein the first tab is configured to limit rotation of the first segment and the second segment relative to one another when compressed.

8. The electrical connector of claim 1, wherein the plurality of segments are configured to generate a spring force along the insertion direction when compressed.

9. The electrical connector of claim 1, wherein the plurality of segments comprise fingers between adjacent segments of the plurality of segments, and wherein the fingers are angled with respect to the insertion direction.

10. The electrical connector of claim 9, wherein the fingers are configured to translate compression along the insertion direction into rotational motion about the axis.

11. The electrical connector of claim 9, wherein the fingers are configured to translate compression of the plurality of segments along the insertion direction into a spring force along the insertion direction.

12. The electrical connector of claim 1, wherein each segment of the plurality of segments is elongated in a direction perpendicular to the insertion direction, and wherein compressing the plurality of segments moves the plurality of segments closer to one another along the insertion direction.

13. The electrical connector of claim 12, wherein rungs of the plurality of segments are configured to ride along fingers between adjacent segments of the plurality of segments to rotate about the axis when compressed.

14. The electrical connector of claim 1, wherein the second segment is at a distal end of the plurality of segments in the insertion direction, and the first segment is adjacent the second segment in the insertion direction.

15. The electrical connector of claim 14, wherein:
the plurality of segments further comprises a third segment;
the first segment is spaced from the third segment in the insertion direction;
the third segment comprises a second tab protruding towards the first segment; and
the second tab is configured to limit movement of the third segment and the first segment relative to one another when compressed.

16. The electrical connector of claim 15, wherein the first tab and the second tab are offset from one another in a first direction perpendicular to the insertion direction.

17. The electrical connector of claim 16, wherein:
the plurality of segments comprise a plurality of tabs that includes the first tab and the second tab; and
the plurality of tabs alternate along the insertion direction between a first position along the first direction and a second position along the first direction.

18. The electrical connector of claim 17, wherein:
the plurality of segments comprise fingers between adjacent segments of the plurality of segments; and
each of the plurality of tabs is positioned, in the first direction, between a respective pair of the fingers.

19. The electrical connector of claim 18, wherein the second tab and a third tab of the plurality of tabs protrude from respective segments of the plurality of segments in a same direction, transverse to the insertion direction, as a first of the respective pair of the fingers and protrudes in an opposite direction, transverse to the insertion direction, as a second of the respective pair of the fingers.

20. The electrical connector of claim 19, wherein the first tab protrudes from the first segment in a same direction, transverse to the insertion direction, as the first of the respective pair of the fingers and protrudes in the opposite direction, transverse to the insertion direction, as the second of the respective pair of the fingers.

21. The electrical connector of claim 19, wherein:
the second segment is at a distal end of the plurality of segments in the insertion direction,
the first segment is adjacent the second segment in the insertion direction, and
a third tab protrudes in the insertion direction toward a farthest segment of the plurality of segments from the second segment in the insertion direction.

22. The electrical connector of claim 1, further comprising electromagnetic shielding for the pair of signal conductors extending alongside the contact tails.

23. The electrical connector of claim 22, wherein the electromagnetic shielding comprises press fit tails on opposite sides of the contact tails.
